(19) United States
(12) Patent Application Publication
(10) Pub. No.: US 2024/0344977 A1
(43) Pub. Date: Oct. 17, 2024

(54) METHOD, APPARATUS AND SYSTEM FOR COMPACT OPTICAL GAS ABSORPTION MEASUREMENTS

(71) Applicant: Servomex Group Limited, Crowborough (GB)

(72) Inventors: Michael Ratcliffe, Crowborough (GB); Bahram Alizadeh, Crowborough (GB); Martin Lopez, Crowborough (GB); Michael Lawson, Crowborough (GB)

(73) Assignee: Servomex Group Limited, Crowborough (GB)

(21) Appl. No.: 18/619,903

(22) Filed: Mar. 28, 2024

(30) Foreign Application Priority Data
Mar. 31, 2023 (GB) 2304895.2
Dec. 29, 2023 (GB) 2320141.1
Mar. 27, 2024 (GB) 2404437.2

(51) Int. Cl. G01N 21/3504; G01N 21/05; G01N 21/39

(52) U.S. Cl. CPC G01N 21/3504; G01N 21/05; G01N 21/39; G01N 2021/399

(57) ABSTRACT

An apparatus comprising a compact, folded path cell for optical gas detection and/or measurement utilising gas absorption spectroscopy. The apparatus includes a source of electromagnetic radiation, a gas sample cell containing reflective elements, and a detector of electromagnetic radiation. The source and detector are arranged between the reflective elements in an arrangement that reflects the radiation away from the source and detector until the reflected radiation has an adequate optical path length, and then reflects the radiation towards the detector. A spectroscopic analysis can be used to determine the presence and/or to measure at least one parameter of at least one gas species within a gas sample.

### CROSS REFERENCE TO RELATED APPLICATIONS

This patent application is entitled to claim priority from UK Patent Application No. 2404437.2 filed on Mar. 27, 2024, UK Patent Application No. 2320141.1 filed on Dec. 29, 2023, and UK Patent Application No. 2304895.2 filed on Mar. 31, 2023, which are incorporated herein by reference.

### FIELD OF THE INVENTION

This invention relates to gas absorption spectroscopy in general and to tuneable diode laser absorption spectroscopy (TDLS) and non-dispersive infrared spectroscopy in particular. The invention has applications in the detection and measurement of one or more species in a gas, such as those produced by an artificial or natural process such as an industrial, medical or physiological process.

### BACKGROUND OF THE INVENTION

An example absorption measurement system consists of a source of electromagnetic radiation such as a tuneable laser source, for example a tuneable diode laser (TDL), or a broadband source such as an incandescent source or light emitting diode (LED) in combination with a wavelength range selective element, such as an optical passband filter or grating. The source emits a beam of electromagnetic radiation that is focussed on to a detector, which may be a solid state photovoltaic, photoconductive, photomultiplier, pyrometer, thermopile or bolometer detector. The substance that is to be analysed is positioned between the electromagnetic radiation source and the detector, so that the electromagnetic radiation incident on the detector may be modified (i.e.. reduced by absorption) by its path through the substance. The modifications to the electromagnetic radiation enable various parameters of the measurand gas to be determined by a signal processing system that is coupled to the detector. Such measurements may take place across an in-situ gas sample measurement volume, such as a process stack or within a measurement gas sample cell, which is the subject of this patent specification. FIG. 1 illustrates a basic extractive absorption measurement apparatus, where 101 is the source of electromagnetic radiation, 102 is the sample cell with transmissive windows at each end and gas inlet 103 and outlet 104, and the detector 105. A signal processing system 106 is used to process the detector signal and produce the measurand concentration based on a calibrated algorithm. In some cases, the substance to be analysed is a gas produced by an industrial, medical or natural process and the measurand may be a parameter of one or more chemical species that are present in this gas. References to a ‘measurand gas’ or ‘measurand species’ in this patent specification are intended to refer to a gas or gas species for which one or more parameters are to be measured or detected; the ‘measurand’ is the presence of a gas species or a measurable parameter of the gas species. Examples of measurand species include, but are not limited to gaseous water, O2, NO, NO2, CO, CO2 and hydrocarbons such as methane or ethane. These measurements are often used for optimising process efficiency and for the monitoring and/or minimising of the production of pollutants and greenhouse gases, as well for the monitoring and/or optimisation of physiological well-being. The presence and/or amount fraction (concentration) of one or more of these measurand species may be determined by absorption spectroscopy measurements using one or more TDLs. However, the conversion of observed changes in electromagnetic radiation intensities to useful physical parameters, such as concentrations and temperatures, requires a series of assumptions to be made regarding the measurand species and measurement apparatus. The term electromagnetic radiation covers a very broad wavelength range and often, but not exclusively, absorption spectroscopy measurements occur in the ultraviolet, visible and infrared regions of the electromagnetic spectrum. Illustrations within this patent will be given for the infrared light region of the electromagnetic spectrum, for obtaining absorption spectroscopy measurements corresponding to certain molecular vibrational energy transitions, but the same principles may be applied to other relevant wavelength regions and should not be considered limited to this spectral region. For ease of expression, throughout this patent specification, the terms electromagnetic radiation or light may be used interchangeably and should be interpreted as being equally applicable to the ultraviolet, visible, infrared or other relevant range of the electromagnetic spectrum.

In operation of an example laser gas analyser system, the wavelength of the beam emitted by a TDL is scanned over a range of wavelengths including one or more absorption lines of the measurand gas species. At specific wavelengths within the range of wavelengths scanned, light is absorbed by the measurand gas, and these spectral absorption lines can be detected by measuring changes in the light flux through the substance to be analysed.

In operation of an example broadband gas analyser system, the source emits over a relatively broad wavelength range (encompassing at least one relevant absorption line), even if limited via the use of an optical passband filter or diffraction grating, and the throughput intensity is modified by absorption simultaneously occurring over one or more absorption lines of the measurand gas species. The integrated effect of the spectral absorption line(s) can be detected by measuring changes in the light flux through the substance to be analysed due to the presence of the measurand.

Absorption lines have characteristic “shapes” in wavelength space that are dependent on the intrinsic physical properties of the gas species (bond angles, bond lengths, number of electrons), as well as the extrinsic physical properties (velocity, temperature) and properties of the environment (pressure, composition of surroundings, etc.). The following paragraphs attempt to give a brief overview of the mechanisms by which these shapes are produced and to give some insight about current practical limitations concerning the recovery of useful properties, such as concentration and temperature, where other perturbing factors are not, or cannot be, well-defined.

In the context above, an absorption “line” is an observable change in light transmission, which coincides with a frequency (wavelength) interval over which a photon may induce a gas molecule to transit from one quantum state to another. The probability that a photon with a particular wavelength and polarisation will elicit transition of quantum states is given by the transition's absorption cross section. The transition dependent cross section can be estimated from first principles, but, in practice it is typically measured experimentally with high accuracy.

Since the interaction of light with matter is inherently quantum in nature, the degree to which a measurand gas species with a fixed chemical identity absorbs light of a given frequency is determined not only by its number density in the measurement path, but also by its precise quantum mechanical state. For any given gas species, there will exist numerous quantum states with spectroscopically distinct absorption properties.

From the Heisenberg uncertainty principle, it follows that the energies of quantum states cannot be precisely defined. This uncertainty causes a smearing of the photon energies required to elicit a transition between two states, preventing spectral lines from becoming infinitely narrow. The statistical impact of different broadening mechanisms can be gathered into a frequency dependent term referred to as the “spectral line-shape”.

As mentioned earlier, the energies of a molecule's quantum states can be perturbed by its physical environment. For example, outside of a perfect vacuum, molecules collide with other particles. These collisions, like photons, can induce changes in quantum state of the molecule, such that the natural lifetime of the original states is shortened. In gaseous states, the influence of this collisional broadening, to a great extent, resembles natural broadening and, accordingly, its influence is generally treated as a modification to the Lorentzian full width half maximum (FWHM) height. However, in contrast to natural line broadening, the pressure contribution has a more complex relationship with the absorption line shape. Pressure broadening, which is applicable to gases only, for a given set of conditions, can be deduced by physically measuring the line shape and carefully subtracting other known broadening mechanisms. This is often impractical and frequently the collisional broadening is only catalogued at “Normal Temperature and Pressure” (NTP) in the absence of other gases and in air. The resultant values may then be fed into mathematical models, so that linewidths corresponding to different conditions may be extrapolated.

The thermal motion of a measurand gas will cause its constituent molecules to possess a range of velocities in relation to the light source. If one considers these molecules to be “observers” of incoming photons, these photons will appear red or blue shifted. At any given temperature, to conserve energy and momentum, lighter molecules will travel faster, on average, compared to those which are more massive. Therefore, thermal broadening has a positive relationship to temperature and an inverse relationship to molecular mass.

From the paragraphs above, it follows that for most practical spectroscopic applications, where temperature and pressure have an appreciable effect, the resultant transition profile is neither completely Lorentzian nor Gaussian in shape. For this reason, it is known to make use of a “Voigt” profile, which is a convolution of the Lorentzian and Gaussian line shapes.

It is possible to accurately determine, for example, changes of the volume density of a measurand gas in a straightforward fashion, provided the perturbing factors listed above are stable and there are no variations in incident light intensity and measurement path length. Such variations may occur, for example, during thermal flexing and mechanical vibrations of the measurement chamber. Variations in incident light intensity may be caused by a number of factors other than absorbing molecular density changes. For example, variations can be caused by intrinsic fluctuations in the laser output, changes in ambient light intensity levels and/or obscuration in the process sample stream, which may be caused by any combination of dust, tar, corrosion or optical beam misalignment. In an extractive or laboratory setting such environmental factors may be limited, for example, by chemical and/or physical filtration to eliminate dust and/or other physical contamination and the presence of undesired chemical species such as water, or mitigated, for example, by compensating for or controlling the ambient temperature and/or pressure. Even in this situation, compensation in light intensity fluctuations may still be desirable due to source instability or drift (as described, for example, in U.S. Pat. No. 9,546,902). The inventors of the present invention have provided a solution that is particularly well-suited for an in-line, extractive environment such as in a laboratory or equivalent environment, although it could also be employed in an in-situ measurement, such as a pipe or stack.

A further cause of measurement uncertainty can be present due to spatial averaging. This type of uncertainty arises, due to the fact that the spectroscopic measurements described above reduce the state of a 3-dimensional system to a 1-dimensional transmittance value. This means that any variations over the pathlength will be averaged, so that all spatial information is completely lost. Assuming that these parameters are not constant along the measurement pathlength, which is especially the case for in-situ gas measurements, this can present major challenges for useful signal recovery.

Direct and indirect cross interference may also occur. This interference results from the effect that the partial pressure of a foreign gas has on the measurement, either through “direct” overlap of absorption lines within the measured wavelength range or from the “indirect” effect of the foreign gas colliding with the measurand gas and modifying the measurand gas absorption line. The composition of the measurement stream is seldom known with precision; if it were, the requirement for the measurement would be nullified and therefore it follows that the line shape produced by a fixed quantity of measurand gas may vary unpredictably if the partial pressures of foreign, broadening gases are not known. Direct cross interference, when caused by a foreign gas, will always result in some degree of additional indirect cross-interference. Depending on the spectroscopic technique used, this may have a significant impact on the measured transition intensity. For example, where wavelength modulation spectroscopy (WMS) is employed, the recovered line intensity is dependent on the ratio of applied amplitude modulation and transition linewidth. It follows that indirect cross interference, in this situation, necessitates a measurement technique whereby the line shape is constantly measured and used to normalise fluctuations in the transition intensity. Any uncertainty in the line shape arising from, for example, electronic noise, will be coupled into the measurement signal, to the detriment of its precision and accuracy. Alternatively, a measurement from a secondary sensor may be used as a normative input although, once again, uncertainties still couple into the measurement and multiple sensors may be needed to achieve full coverage of interferents.

Another potential cause of fluctuations in the optical detector signal, which is not due to direct fluctuations in the ambient light or laser output signal, is the occurrence of constructive and destructive optical interference (etalons) causing an oscillation in the detector signal as the laser is scanned across the measurement wavelength range. Optical interference will even be present, to some degree, with an incoherent broadband light source, due to random effects, but the use of coherent laser light, for example, means that any reflections at any optical surfaces or interfaces along the optical path from the laser output to the detector surface (for example from surfaces/interfaces such as, but not limited to, windows, lenses and reflective interfaces), lead to the production of reflected light with a phase difference in comparison with the incident light, hence leading to optical interference, where the light rays interact. The phase relationship between this reflected light and the incident light may change with time due to such factors as temperature, vibration and pressure fluctuations, since these factors may cause changes in physical dimensions, density or refractive index.

The detector is integrating this optical interference when producing an intensity signal. Since the phase difference will vary with wavelength along the measure path, the symptoms of this optical interference (or etalons) are typically the production of oscillations on the signal baseline as the laser output is scanned across the wavelength measurement range. These combine with other distortions and cause measurement inaccuracies. The signal “baseline” is the signal that would be seen even if no absorbing signal were present, in other words, the “zero absorption” signal. This baseline signal is superimposed on the actual absorption signal when present. In an ideal world, the baseline would be a straight line (flat line centred at zero in perfect circumstances), but in practice this is never achieved. The baseline may not be perfectly flat across the scan range and may have fluctuations and other distortions (or “noise”), which may be of a random or systematic nature and include the above-mentioned oscillations. These oscillations may also be referred to as “fringe” signals in the case of optical interference. These various distortion effects, of whatever origin, lead to increased uncertainty in the determination of the absorption signal or signals, and hence increased uncertainty in the derived molecular density or concentration of the measurand gas. The uncertainty is compounded where the presence of indirect cross-interference necessitates the measurement of line shape in addition to transition intensity, since the periodic etalon fringes may cause the recovered signal to broaden or narrow.

Methods to decrease such optical interference include reducing reflective or partially reflective surfaces in the light path from source to detector that may form etalons, such as by minimising the number of optical components, using wedge windows rather than parallel face windows or using anti-reflection coating optimised for the desired wavelength range. However, it is impossible, in practice, to completely eliminate this interference effect by reducing reflective surfaces. Where a multi-pass cell is used, interference is unavoidable, as the beam path within a multi-pass cell will always create some amount of optical interference, which is usually significant when the cell is being used for trace level measurements.

Another method to reduce the impact of optical interference on the baseline is to measure and record a reference baseline when no measurand gas is present. This reference baseline may then be subtracted from the live signal to produce a cleaner signal to process. Whilst this may give an immediate improvement to the measurand determination uncertainty, it does not address oscillations on the baseline under changes in ambient conditions (particularly temperature) and hence the effectiveness of this technique is limited.

Another method involves the use of a piezo electric element or similar means to oscillate an active optical element such as a lens or mirror in the optical path. This has the effect of continuously varying the optical pathlengths and hence the phase variations and resultant optical interference. This results in blurring or smoothing down the periodic oscillation on the baseline, through integration over time of the interference fringes formed and therefore reducing the overall effect. However, it adds complexity and cost and suffers from several problems due to using a moving element, such as reduced component lifetime and mechanical failure and, in practice, does not eliminate the problem completely. Moreover, most piezo electric elements require a sufficiently high voltage supply that makes operation in flammable hazardous areas unsuitable.

Other methods make use of the distinct transition line shapes, described earlier, and their difference from the periodic intensity fluctuations arising from optical self-interference. This might be carried out, for example, by least squares fitting a recovered spectrum to a suitable basis-vector which would resemble the expected spectrum in the absence of interference. This method has the advantage that further basis vectors can be employed that resemble the individual spectra of other cross-interfering gases in the measurement. Alternatively, a similar procedure may be carried in the frequency domain using convolution with a suitable kernel function, such as described in U.S. Pat. No. 10,234,378. These methods, however, are limited in that they require assumptions to be made regarding the transition line shape. If it deviates from the expected value, the resulting measurements become inaccurate. For example, if a direct-cross interferent is present in the measurement stream which is not accounted for in the corrective basis-set or frequency domain kernel, such approaches can be detrimental to measurement accuracy. Furthermore, if factors affecting the production of optical noise differ significantly from expected values, such as the free spectral range of the resultant etalon fringes, the efficacy of such approaches is reduced.

A recent novel method (described in UK Patent Application No. GB2113699.9) involves the application of electrical and/or magnetic fields to modify the absorption line characteristics due to the Zeeman and/or Stark effects, whilst leaving the optical interference effects unchanged. In this way, the baseline effect of the optical interference may be deduced and/or decreased or eliminated.

Under constant ambient conditions of pressure, temperature and background gas composition, the fractional strength of the electromagnetic absorption by a gas is dependent on the gas concentration, the fundamental properties of the gas (the extinction coefficient, which is dependent on the wavelength) and the pathlength. The mathematical relationship between these properties is described by the Beer Lambert Law. If a low gas concentration is desired to be determined, sensitivity for a particular gas may be enhanced by choosing a strong absorption line and/or a long pathlength. However, if the absorption of light is too strong, such as if a high measurand gas concentration is present and/or long pathlength, non-linearities and/or absorption saturation may occur, reducing sensitivity with concentration change. Hence, the required sensitivity (which will determine the chosen wavelength and pathlength) is dependent on the required measurement range. The wavelength chosen for the excitation also has pragmatic considerations, such as the availability and cost of excitation sources and detectors. For example, longer wavelength infrared lasers (such as interband or quantum cascade lasers), which may have stronger absorption, may cost considerably more than near infrared lasers (such as vertical cavity surface emitting laser (VCSEL) or distributed feedback (DFB)), which operate using weaker overtone absorption bands and also, for broadband measurements, infrared LEDs typically have increased cost and decreased output intensity, when longer wavelengths are chosen. Once the excitation wavelength or wavelength range has been selected, then the pathlength will be determined by the required measurement range. Long pathlengths may be achieved by simply using a long sample cell, but this may be (physically) impractical and with a slow time response due to the large cell volume, especially if the required pathlength is of several metres or more. Many of these issues may be mitigated, such as by using a multi-pass or folded path cell, such as a Herriott cell (FIG. 2A), White cell (FIG. 2B) or tuned optical cavity, which may reduce the overall cell size considerably. In FIG. 2A, the source of electromagnetic radiation 201 is collimated by a lens 202 and directed into the Herriot cell folded optical geometry 203. Within this cell there are two concave mirrors 204 to steer the beam in multiple folds to increase the pathlength. The detector 205 measures the transmitted radiated intensity. Gas exchange ports 206 allow the sample or calibration gas mixtures to be passed in and out of the cell. In FIG. 2B the source of electromagnetic radiation 207 is collimated by a lens 208 and directed into the White cell optical geometry 209. Within this cell a set of planar mirrors 210 are used to steer the beam in multiple folds to increase the optical pathlength. The detector 211 measures the transmitted radiation intensity. Gas exchange ports 212 allow the sample or calibration gas mixtures to be passed in and out of the cell. In any of the above cases, optical treatment and/or focussing of the excitation beam will be normally required for optimal functionality, needing bespoke optical design elements, such as refractive and/or reflective elements, and precision alignment tuning is needed as part of the manufacturing process. High performance, long pathlength multi-pass or folded path cells will require the use of low temperature coefficient of expansion materials and close temperature control for best performance. In addition, multi-pass cells and optical cavities may be highly sensitive to vibration and contamination.

Thus, there are several problems remaining to be addressed, even when using a multi-pass or folded-path absorption spectroscopy cell for the detection or measurement of gas species. There are instances where an intermediate length folded absorption pathlength may be desirable to obtain some extra absorption benefit, in a more compact format, whilst not requiring the optical complexity and environmental sensitivity of a very long pathlength multi-pass cell. Traditional methods would still typically require beam shaping and/or focusing optics with individual optical tuning (alignment or beam shaping) process for such a format.

### SUMMARY

The inventors of the present invention have determined that it is possible to provide a compact, folded path, easy to assemble device for gas measurand measurements, which does not require individual optical tuning and is tolerant for vibration and contamination. A first apparatus for use in gas detection and/or measurement using absorption spectroscopy comprises:
a gas cell with at least one gas exchange port;
at least one source of electromagnetic radiation, the source being arranged to transmit a diverging beam of electromagnetic radiation in a direction to pass through the gas cell;
at least one detector for detecting electromagnetic radiation that is incident on the detector; and
at least first and second mirrors arranged within the gas cell in opposed relation to each other, wherein at least the first mirror is a curved mirror and wherein the opposed mirrors are arranged to reflect the transmitted beam in a folded optical path through the gas cell between the at least one source and at least one detector;
wherein at least one source is located at a position that is offset from a central optical axis that passes through the centre of curvature of the first mirror, such that transmitted electromagnetic radiation is incident on a first surface region of the first mirror at a non-zero angle relative to a direction normal to the first surface region and such that the transmitted electromagnetic radiation that is incident on the first mirror is reflected away from the source towards the second mirror, and wherein the second mirror is arranged to reflect the electromagnetic radiation towards a second surface region of the first mirror.

The at least one source may be located between the opposed mirrors. Locating the light source between the mirrors, and arranging the components such that the folded optical path avoids the reflected light being incident on the source, enables a compact optical device to be provided with an adequate optical path length for absorption spectroscopy. The use of curved mirrors and suitable positioning of the components can provide automatic convergence of a transmitted divergent beam towards the detector, allowing the use of low-cost light sources and low-cost manufacture without the need for focussing lenses. This patent specification describes various examples of apparatus and systems for spectroscopic absorption measurements. The inventors have determined that the apparatus can be implemented as a robust, potentially high light throughput, lensless, compact, extended pathlength, auto-focussing, low noise, simple to assemble folded path optical cell for gas spectroscopic absorption measurements. The inventors have determined that it is possible to use diverging or collimated light sources without expensive focussing lenses, by a selection of reflective surfaces and their positioning relative to the source and detector.

A second apparatus, an example of which is shown in FIG. 3, is provided for compact optical gas detection and/or measurement in an absorption spectroscopy system. The apparatus comprises:
a gas cell for containing a gas sample or calibration gas with at least one gas exchange port and at least one optical element for allowing transmission of electromagnetic radiation of a desired wavelength range in and out of the gas cell; and
at least one source of diverging or collimated electromagnetic radiation for transmitting electromagnetic radiation through a gas sample contained within the gas cell and towards at least one detector;
two or more mirrors arranged in opposed relation to each other, including at least one curved mirror arranged to reflect the transmitted electromagnetic radiation towards a second mirror, wherein the second mirror is arranged to reflect the electromagnetic radiation back towards the at least one curved mirror, and wherein said two or more mirrors are arranged to reflect the electromagnetic radiation in a folded optical path through the gas sample towards the at least one detector such that the transmitted diverging or collimated electromagnetic radiation converges towards the at least one detector;
at least one detector to monitor absorption of electromagnetic radiation for at least one absorption wavelength or wavelength range associated with at least one gas species, by detecting transmitted electromagnetic radiation that is not absorbed; and
at least one analyser for analysing an output signal from the at least one detector to determine the presence and/or measure a parameter of at least one gas species within the gas sample.

In an example, the at least one curved mirror comprises at least one spherical or approximately spherical mirror, and the apparatus is arranged to converge the transmitted electromagnetic diverging or collimated electromagnetic radiation towards the detector. The at least one curved mirror is arranged in an opposed relation relative to the second mirror, so as to define a folded path trajectory for electromagnetic radiation transmitted through the gas sample contained within the gas cell. The at least one spherical mirror (or curved mirror) may be provided as one or more separate mirror sections, each corresponding to a section of the same spherical surface but potentially separated from each other. It is not essential for the curved mirror to be a continuous mirrored surface if the transmitted beam and reflected beam are only incident on parts of the surface, and so a pair of discrete sections of a mirror would be satisfactory.

If the at least one source of electromagnetic radiation is located at a distance from a spherical mirror which is approximately equal to half the radius of curvature of that spherical mirror, a diverging beam of electromagnetic radiation from the source that is incident on the spherical mirror will be reflected as an approximately parallel beam. This can be reflected off a planar second mirror such that the reflected parallel beam is then incident on the spherical mirror for a second time, and is then reflected as a converging beam towards a detector. The detector can be located at a distance from the spherical mirror which is approximately half the radius of curvature of the spherical mirror. The planar second mirror can also be located at a distance from the spherical mirror which is roughly half the radius of curvature.

In an example, the electromagnetic radiation trajectory follows a folded path; where said folded path is provided by:
directing the output from a diverging or collimated electromagnetic source towards the at least one spherical or approximately spherical mirror,
reflecting the electromagnetic radiation from the spherical or approximately spherical mirror onto the second mirror, which may be an approximately flat or cylindrically concave mirror,
reflecting the electromagnetic radiation from the approximately flat or cylindrically concave mirror onto the spherical or an approximately spherical mirror,
reflecting the electromagnetic radiation from the spherical or approximately spherical mirror onto at least one optical detector.

In an example of the above-described first apparatus, as shown in FIG. 16, the second opposed mirror may be a second spherical mirror having the same radius of curvature as the first spherical mirror, located at a distance from the first spherical mirror corresponding to their radius of curvature. In such an implementation, a diverging beam of electromagnetic radiation from a source located at a distance of half the radius of curvature of the first mirror will be reflected as a substantially parallel beam; and then the parallel beam of electromagnetic radiation will be incident on the second mirror, and will be reflected back as a converging beam focussed at a distance of half the radius of curvature, which then diverges again before being incident on the first spherical mirror for a second time. The first spherical mirror will reflect this back as a parallel beam which is incident on the second spherical mirror, and the second spherical mirror will again reflect the radiation so as to converge towards a focus point at a distance of half the radius of curvature from each mirror. This has the advantage of extending the optical path compared with the previously-described example implementation of FIG. 3, while still enabling a diverging beam of electromagnetic radiation from an inexpensive source to be automatically focussed on a detector by the two opposed mirrors. This is shown in FIG. 16, in which the source 1601 and detector 1602 are located ‘back-to-back’ so that the electromagnetic radiation is emitted towards a first mirror 1604 and the detected radiation is reflected towards the detector from the second mirror 1605.

The spherical or approximately spherical mirror or mirrors may each comprise a segment of a spherical surface or a plurality of segments of the same spherical surface.

In an example implementation, the at least one source and at least one detector are mounted adjacent an approximately flat or cylindrically concave second mirror. For example, the source and detector are approximately co-planar with each other and parallel to the plane of an approximately flat second mirror. An example mount is shown in FIG. 3.

In another example implementation, which may be combined with features of the above examples, the optical path followed shows approximate central reflectional and/or rotational symmetry between the at least one source and at least one detector and interchanging the positions of the at least one source and at least one detector results in an approximately identical optical path.

This interchangeability of the at least one source and detector provides significant advantages in the design, assembly and test of the sensor. Examples of these advantages are the reduction in the number of unique parts, simplification of stamping or moulding processes, easier assembly and, in particular, error-proof assembly in a production environment.

It is also envisaged by the inventors that at least two folded path geometries, as described in this patent specification, may be combined. In some examples, two or more additional mirrors may be located in the optical path between the source and the detector. In such a combined system, instead of arriving at the at least one detector, the converged light from a folded path geometry described above is presented as a diverging source fed into another folded light path geometry. This extends the pathlength. A number of different folded path geometries and different orientations of the planes of folded path cells relative to each other are possible, to allow the total required pathlength to be achieved. Alternatively, a more compact version may be achieved by replacing the detector with a mirror to reflect the light into at least one additional optical system and locating the detector to receive the light after being reflected by the at least one additional optical system.

Other features and functions may also be integrated in and around the cell in order to enhance its optical performance, environmental stability and signal processing. These optional features and functions may include optical elements including windows, lenses, mirrors, attenuators, optical band pass filters, or reference cells for line locking and/or validation. Additionally, physical and spectroscopic features can be used to minimise stray optical reflections, such as using surface roughening and/or blackening, or environmental factors including gas flow, temperature and pressure may be controlled and/or corrected. In some examples, flow and/or diffusional features (such as gas ports for flow-through and/or gas ports with diffusional exchange membranes, referred to collectively as ‘gas exchange ports’ in this patent specification) and volume reduction features are used to reduce response time. In some examples, the application of electrical and/or magnetic fields to the measurement cell and/or other regions, and/or path modulation is used to reduce etalon effects.

Another enhancement is to introduce a gel or other suitable substance into a gas detection/measurement apparatus, with approximate refractive-index-matching of this gel to the optical elements that separate the light source from the measurement cell. The reason for adding this gel or other suitable substance is to minimise dead space in the apparatus, to reduce the need to chemically scrub regions, and potentially offering a secondary barrier to gas ingress in the case of failure of the seal of the sample cell. This is especially relevant for flammable and/or toxic gas mixtures, but also helps to deal with the spectral interference and reflective losses/etalons that would otherwise occur between the source, detector and at least one optical element. Signal processing including frequency domain, filtering and averaging techniques may also advantageously be employed.

In the example of FIG. 3, the source (301) and detector (302) may be mounted on a common coplanar surface (303), which may be a printed circuit board. Although the source 301 of FIG. 3 is shown schematically in a container, the source and detector may advantageously be provided in a Chip-On-Board (COB) format and located closer to the entry and exit windows 304 of the sample cell 307. Radiation from source (301) which may be collimated or diverging, passes through a first optical element (304), which may be at least one of the following: flat window, wedge window, attenuating window, bandpass filter. The radiation passes through the sample gas in the sample cell body (307) as it is reflected between the curved or spherical mirror (306) and second mirror (305) within the cell and passes through a second optical element (304) which may be at least one of the following: flat window, wedge window, attenuating window or bandpass filter to reach the detector (302). The sample gas enters and leaves the main cell body through inlet and outlets (308).

In some example implementations, the detector (302) may be at the focal point of the optical geometry, whilst in other examples it may be chosen to be at a de-focused position. A de-focused position may be preferred to reduce optical saturation at the detector and decrease tolerance requirements for positioning of the detector (302).

In the example of FIG. 4, radiation from the source (401) enters the sample cell (405) and is reflected by a first curved or spherical mirror (403) onto a second mirror (407), back onto the first mirror (403), which then focuses the light as it exits the first cell (at convergence point 408) which then becomes the input into the second cell (409). In a likewise manner, the light is reflected by the mirrors (404) and (407) within the cell (409) and is focused onto the detector (402). Sample gas is allowed to pass through the cell via inlet and outlet ports (406).

### BRIEF DESCRIPTION OF DRAWINGS

Example systems and methods are described below with reference to the accompanying figures in which:

FIG. 1 shows a prior art arrangement of a spectroscopic absorption gas analysis system for making extractive sample gas measurements;

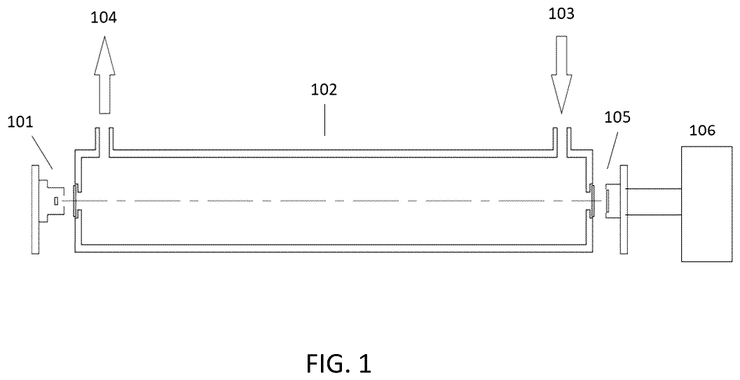

FIGS. 2A and 2B show a prior art arrangement of a spectroscopic gas analysis system with a folded pathlength by using multiple reflections, from a collimated light beam;

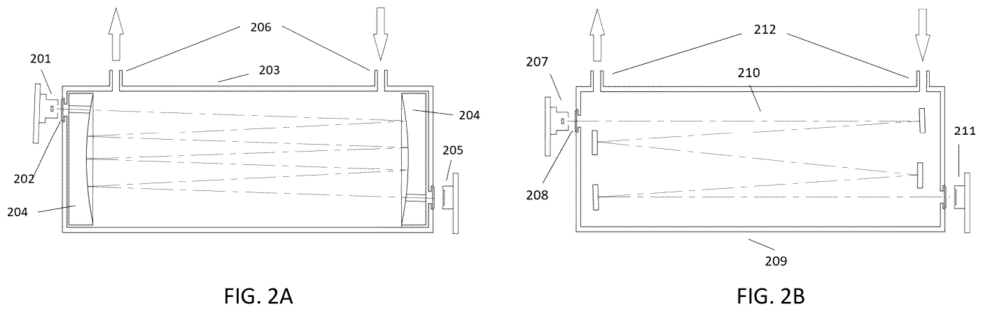

FIG. 3 shows an example spectroscopic gas analysis system, using the current invention;

FIG. 4 shows an example of a spectroscopic gas analysis system, using the current invention where a combination of two or more folded path cells are used to increase the overall absorption pathlength;

FIGS. 5A and 5B illustrate the design considerations for a spherical mirror geometry cell;

FIGS. 6A and 6B show reduced volume cells for faster time response with and without inserts;

FIGS. 7A to 7F illustrate diffusion and flow-through design regimes for the sample cell;

FIG. 8 shows an example embodiment of a spectroscopic gas analysis system with two sources and two detectors;

FIG. 9A illustrates the optical geometry of a single measurement, whereas FIG. 9B shows 3 independent measurements in a circular geometry;

FIGS. 10A and 10B illustrate a chip on board design;

FIGS. 11A and 11B illustrate the comparison between diffraction patterns produced by rectangular and circular apertures;

FIG. 12 shows the comparison between the optical fringe normalised amplitudes produced by circular and rectangular apertures;

FIG. 13 shows the inclusion of a wavelength lock cell into the device;

FIGS. 14A to 14D show examples of spectroscopic gas analysis systems, using the current invention; where sample gas, a purge gas or reference gas is flowed through the dead space or a scrubber or a gel is applied to the source and/or detector dead space regions;

FIGS. 15A and 15B show examples of spectroscopic gas analysis systems using the current invention; where an electric and/or magnetic field is applied to one or more regions;

FIG. 16 illustrates an alternative optical geometry embodiment with longer pathlength per cell length;

FIG. 17 illustrates the folded optical path of a transmitted divergent beam of light when reflected within the gas cell of FIG. 16, showing the light converging on the detector; and

FIG. 18 shows the main physical structures of an example apparatus according to FIGS. 16 and 17.

### DETAILED DESCRIPTION

As noted above, absorption spectroscopy is known for use in gas analysis, including for determining the presence of at least one particular gas species in a measurement volume and for measurement of parameters including concentration of the individual gas species in a gas sample.

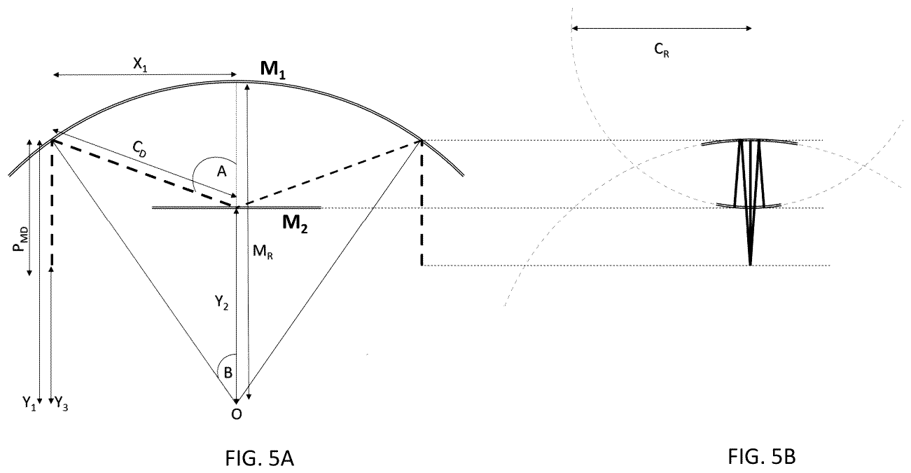

Various physical design parameters may be used to assist in the design of optical cells for use in absorption spectroscopy, as described in this patent specification. An example is illustrated in FIGS. 5A and 5B for a non-zero pathlength (PL) using a spherical mirror. The total pathlength is shown in dashed lines. In this example, the radius of curvature of the approximately spherical mirror (MR) corresponds to approximately half the desired pathlength. The parameters used to describe the example optical lay-out are shown in in the equations below and illustrated in FIG. 5A, for an angle A between 0 and 90o:

$${M}_{R} = \frac{{P}_{L}}{2} \qquad ( 1 )$$

$$B = \frac{A}{2} \qquad ( 2 )$$

$${X}_{1} = sin ( B ) \times {M}_{R} \qquad ( 3 )$$

$${Y}_{1} = cos ( B ) \times {M}_{R} \qquad ( 4 )$$

$${C}_{D} = \frac{{X}_{1}}{sin ( A )} \qquad ( 5 )$$

$${P}_{MD} = \frac{{P}_{L}}{2} - {C}_{D} \qquad ( 6 )$$

$${Y}_{2} = {Y}_{1} - {C}_{D} \times cos ( A ) \qquad ( 7 )$$

$${Y}_{3} = {Y}_{1} - {P}_{MD} \qquad ( 8 )$$

where A is the angle between the vertical central line of the two opposed mirrors (M1 and M2) and the central line of the reflected beam, B is the angle between the vertical central line of the mirrors and the point of intersection of the central line of the reflected beam on the spherical mirror (M1), X1 is the distance between the central line and the source or detector, Y1 is the distance between the horizontal axis containing the point of origin (O) of the spherical mirror and the point of intersection of the central line of the reflected beam on the spherical mirror (M1), Y2 is the distance between the origin (O) and the second mirror (M2), the central distance (CD) is the distance from the centre of the second mirror (M2) to the point of intersection of the central line of the beam which is incident on the spherical mirror (M1), and the pre-mirror distance (PMD) is the distance between the source or detector and the spherical mirror (M1).

In the case of a narrow cross section of the spherical mirror (high aperturing) or a low beam divergence, this may also be approximated by a cylindrically concave mirror or other curved mirror surface. The use of a cylindrically concave mirror instead of spherical mirror reduces manufacturing complexity and cost. Alternatively, a parabolic mirror surface could be used.

Note that FIG. 5B is a central cross section perpendicular to the plane of FIG. 5A. It shows that the second mirror M2 should, ideally, be a curved mirror to focus the reflected beam, such as a cylindrically concave mirror of radius (CR):

$${C}_{R} = {F}_{OA} \times \frac{{Y}_{1}}{( 4 \times ( {Y}_{1} - {F}_{OA} ) )} \qquad ( 9 )$$

where the off axis focal length (FOA) is given by:

$${F}_{OA} = {Y}_{1} - {Y}_{2} + {P}_{MD} \qquad ( 10 )$$

As described earlier, in certain examples, this cylindrical concave mirror may be approximated by the use of a planar mirror instead.

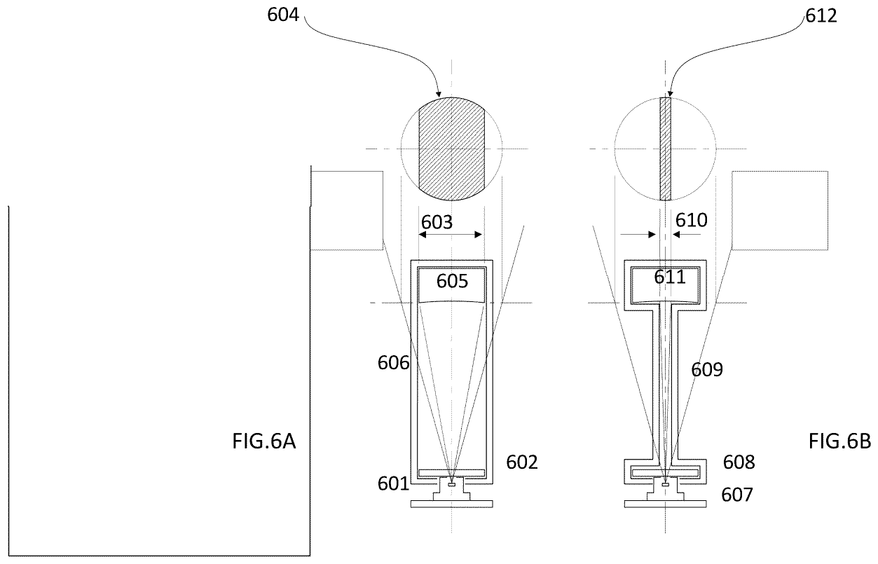

The use of reflective optics is advantageous compared to refractive optics for several reasons including having a higher optical throughput (greater transmission) and being independent of wavelength (chromatic aberration), which is especially important for a modular system for the detection of many different gas species at different wavelengths. Note that, although, in principle, a cylindrically concave mirror should be used as the second (lower) reflective surface in FIGS. 5A and 5B in order to focus to an approximate spot at or near the detector, a useful configuration may still be obtained by using an approximately flat second mirror instead; this is easier to manufacture and lower cost, especially where only a small cross-sectional slice depth is used, since the light will still be focused in one plane. The depth of the cross-sectional slice to be used (such as the different options of FIGS. 6A and 6B) is influenced by the required sample cell volume, light throughput efficiency and mechanical considerations, such as space available and any multi-cell stacking requirements. A lower depth may decrease the flush time of the cell under the same conditions, either through flow, diffusion or in combination, enhancing the volume exchange time, but, depending on the output angle of the optical source, a reduced solid angle of light output may be collected at the detector. Sometimes, counter-intuitively, using a less efficient optical through-put may be desirable, where the enhanced fractional signal change, due to increased pathlength is required, but the unattenuated signal, for example from a laser diode, LED or incandescent source, may be too intense and saturate the detector signal or the laser intensity may be too high for use with combustible gas mixtures. The reduced cell depth may be achieved by intrinsic physical design and/or, in some embodiments, by using inserted elements to reduce the cell volume. FIGS. 6A and 6B illustrate these concepts where FIG. 6A shows a larger depth (603) cell with the source (601) emitting a diverging light beam through the optical element (602) into the sample cell (606) where the beam is apertured by the cell depth (603) before being reflected by the approximately spherical mirror (605). This has a relatively wide cross-sectional area of the beam (604) compared to FIG. 6B (612). In FIG. 6B diverging light from the source (607) passes through the optical element (608) and enters the sample cell (609) and is more apertured to a smaller depth (610).

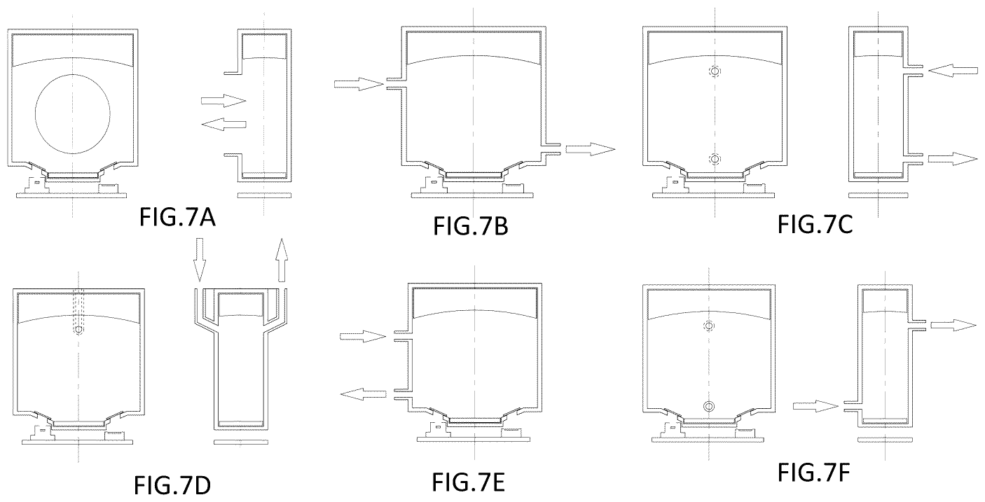

The flush time for the sample cell will be determined, amongst other factors, by the sample cell volume and sample gas flow and/or diffusion rate, but other factors are also important such as the surface shape, composition and roughness and flush path taken by the gas. For a flow regime, a faster flush time may be achieved where the full volume is accessible to the flow and turbulent flow is also present. There are many possible flow regimes including gas inlet(s) and outlet(s) from the same side, or from opposite sides, from the top or from the bottom and/or from a combination of sides and FIGS. 7B to FIG. 7F illustrate some possible configurations. The size, shape and the surface finish of the gas inlets and outlets may be optimised for certain applications. For example, if a back pressure is required, the cross sections of the outlets may be chosen to be smaller than the inlets. Conversely, if a small pressure drop across the cell is desired, a larger cross section for the outlets may be chosen. In the case of diffusion, for example, for a rectangular cross section design, where the length of the cell is longer than the depth, a top and/or bottom diffusion design will give a faster response since the diffusion rate is proportional to the cross-sectional area and inversely proportional to the diffusional depth and a possible configuration is illustrated in FIG. 7A. Consideration should be given to not only the required flow/diffusion regime, but also the impact of the size, position and the surface finish of the inlets/outlets on the optical properties of the sample cell with regards to its absorptive and reflecting properties.

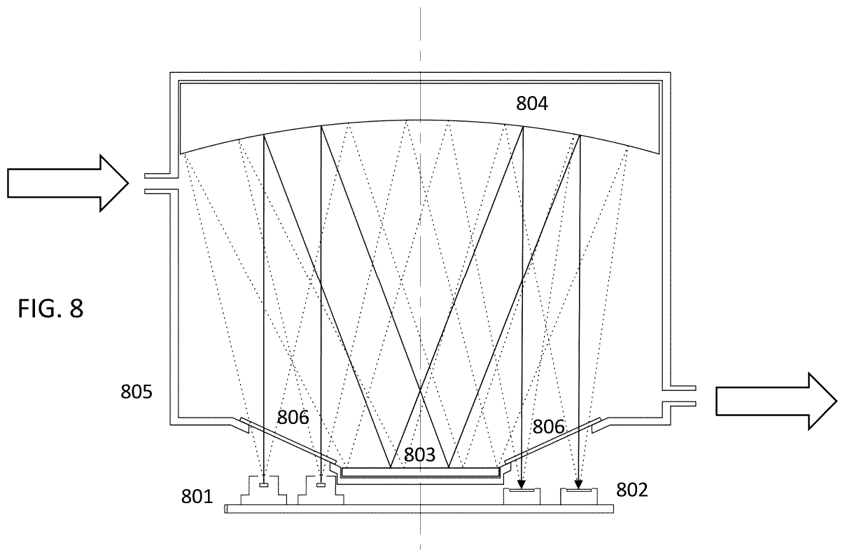

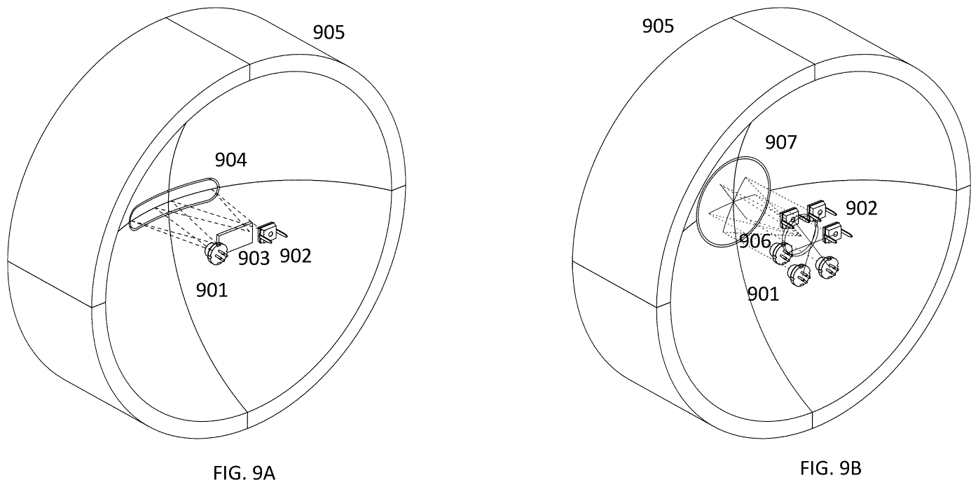

Multi-gas measurements may also take place, where two or more lasers and/or detectors are used. In a preferred embodiment (FIG. 8), at least two sources (801) and two detectors (802) are mounted in the same plane and axis. Although the light sources 801 and detectors 802 are shown in relatively large containers, these components could be provided in a Chip-On-Board arrangement in closer proximity to the entrance and exit windows 806. In this case, the diverging beams from the sources (801) pass through the optical elements (806) and are reflected by the spherical mirror (804) and second mirror (803) and, after passing the second optical element (806), are focused on the detectors (802). The wavelengths of the sources are chosen to correspond to the absorption wavelengths of interest for the two different measurands. Likewise, the detectors are chosen to have responsivities in the wavelengths of interest for the measurands. Due to the optical properties of the cell, each source will focus on its corresponding detector as can be seen by the arrows in FIG. 8, which indicate the central beam trajectories. In some applications more than two matched pairs of sources and detectors may be used depending on the measurands and the sizes of the components and the optics used. Multiple sources and detectors may also be used in a circular mirror format, as shown in FIGS. 9A and 9B. This may be a preferred embodiment, where many measurands are required to be measured simultaneously and or sequentially within a compact format, which also allows the use of standard circular rather than rectangular mirror optics. To illustrate this principle, initially a single measurement will be considered as illustrated in FIG. 9A. The diverging beam from the source (901) is reflected by the spherical mirror (904) and second mirror (903) and is focused on the detector (902). The wavelength of the source is chosen to correspond to the absorption wavelength range of interest for the measurand. Likewise, the detector is chosen to have responsivity in the wavelengths of interest for the measurand. Note that the spherical mirror (904) consists of a cross-sectional slice of the approximately spherical mirror (905). The dimensions of this cross-sectional slice (904) may be chosen according to the beam divergence, pathlength and the aperturing required for the application and may also be chosen to be in a rectangular format. In the case of multiple measurements, the first spherical mirror cross-sectional slice (907) and the second spherical mirror (906) may be chosen to have circular geometries. This allows multiple measurements to take place using multiple sources (901) and detectors (902) where each matched pair on the same plane and axis behaves as the matched pair in FIG. 9A.

In some preferred embodiments, signal processing may take place using analogue and/or digital electronics, including the use of multiplexed ADCs and/or processors.

The mirrors may be made of machined and/or moulded metal, glass or polymer and polished as required and may have reflective and/or protective coatings such as gold. In the case of less than the full solid angle of light from the source being reflected by the approximately spherical mirror, it may become important, especially for coherent sources, such as lasers, to suppress stray reflections from being collected at the detector, since constructive and destructive interference effects (etalons) could occur. The suppression of these stray reflections may take the form of random surface roughening to disrupt specular reflection and/or blackening (optically absorptive coating) of the relevant surfaces. Any such applied optically absorptive coating or material should ideally be chemically compatible with the gas sample that it is in contact with and approximately a perfect light absorber at the optical wavelength range being used. Alternatively, in some preferred embodiments, for example, with broadband (e.g. for non-coherent LED or incandescent) sources, stray reflections which arrive at the detector may actually be useful, to increase the overall optical throughput and give improved signal to noise and therefore no suppression of reflections is needed and/or these stray reflections may even be enhanced, for example, by the application of a reflective layer to at least one surface within the sample cell, such as a gold layer.

Any interaction with at least one optical element or reflective feature such as an attenuator, pass band filter, window, lens, polariser (e.g. for use if not all the laser output is intrinsically polarised) or reflective surface may cause an etalon to form. In general, the number of optical elements should be kept to a minimum, to minimise etalon formation, but there will always be some elements or features present, such as windows for the source and/or detector and for light entering into and exiting the sample cell. In some applications, where the stray light reflections should be minimised as discussed in the previous section, the formation of such etalons may be minimised by the use of anti-reflective coatings and/or angled and/or wedge windows. In addition, dimensional changes may cause shifts in the etalons and hence affect the signal. This can be reduced by the use of low thermal expansion coefficient materials such as invar and/or using a temperature-controlled cell. The use of a temperature-controlled cell and/or pre-equilibrator for the sample gas, so the incoming gas is in equilibrium with the cell temperature will increase signal stability.

The magnitude of the etalons and changes with temperature may be reduced by the use of at least one pathlength modulator. The at least one modulator may be employed at different locations within the system, depending, amongst other considerations, on the locations of the most relevant etalon producing features and the overall opto-mechanical arrangement. The modulator may be a solid state device, such as a piezo-electric device, whose dimensions may be changed via the application of a voltage, although consideration of the voltage magnitude should be taken into account for potentially flammable mixtures. Alternatively, the modulator may be an electromechanical device, such as a voice coil type arrangement in combination with a permanent magnet, similar in design to a loudspeaker or an electromechanical vibrating element. A mechanical flexure may be employed, such as a spring or elastic polymer or foam, to act as a director and damping element. In the case of a foam being used, a sealed cell format may be preferentially employed to modify the physical properties of the flexure such as density and/or elastic properties without entraining sample gas. In some embodiments, modulations on pathlength may be preferentially applied to the approximately spherical mirror slice cross-section (306), since this has less influence on the focussing position at the detector than if the approximately flat or concave mirror (305) were modulated. The frequency of any such modulation should take into account the functional scan speed in the case of a diode laser measurement or pulse rate in the case of LED's or pulsed incandescent sources and the expected response time, so as not to detrimentally influence the measurement. The amplitude of the modulation should ideally be greater than the wavelength of light being used, however the frequency and amplitude may be chosen theoretically and/or empirically to give the desired performance and/or lifetime of the modulating element.

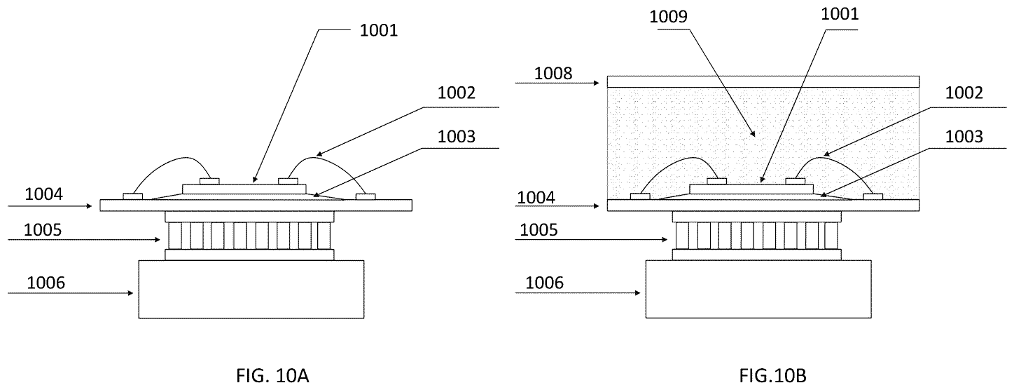

The novel design of optics described in this patent requires no lenses mounted near the source, such as a laser diode. For example, in most conventional laser optics, lenses are commonly designed to be co-mounted within the laser diode metal can package or in close proximity to the laser diode can window. The novel design described in this patent removes the need for any special metal package for the laser diode, although standard metallic, sealed diode packages with flat, angled and/or wedge windows may still be advantageously employed within this device. However, this is an important advantage which allows the use of the bare laser device in its native diverging cone of light chip format. There are several advantages to using the Chip-on-Board (COB) format for the laser device such as reduced cost, less packaging material, lower etalons, higher optical transmission and significantly reduced heating and/or cooling power needed to maintain the laser chip at an accurate setpoint temperature and tighter temperature control, due to the lower thermal mass and higher thermal transfer efficiency. Chip-on-Board (COB) technology describes the mounting of the bare VCSEL or laser chip in direct contact with the substrate or (copper) plane of the PCB (FIGS. 10A and 10B). Among the advantages of COB are compactness, provision of the best thermal coupling of the laser (1001) to the thermo-electric cooler (TEC) (1005), and the elimination of any optical fringes formed inside a conventional metal can-window enclosure of a laser diode. The COB process consists of three main manufacturing processes. The first is the die mount or “die attach” (1003), which consists of applying a special conductive adhesive to secure the chip directly to the PCB substrate (1004). The second is the “wire bonding” (1002) process which makes electrical connections between the laser chip and PCB pads. In some embodiments, such as shown in FIG. 10B, a third process is “encapsulation” (1009), which consists of dispensing a very thin layer of clear epoxy or gel over the die and the wire bonds. Ideally, this encapsulant is refractive index matched to the optical elements (1008), which may be one or more of the following: a window, an attenuator, a band-pass filter. Heat generated by the TEC (1005) is dissipated by a suitable heatsink (1006). Due to the small size of the laser chip and its direct thermal contact with the PCB copper areas, a significant reduction is achieved in the amount of TEC power required to maintain the laser chip at a desired setpoint temperature. Additionally, the significantly lower thermal capacity of the bare chip allows for very fast and accurate thermal tuning of the laser temperature and its wavelength.

Although the above section has described the advantages and implementation of chip-on-board for a laser diode source, similar preferred embodiments may use a chip-on-board diode laser, LED source and/or solid-state detector. The detector may be a photodiode.

When designing the opto-mechanics of the sample cell and related optics there are two important considerations to take into account:
1—It should provide path length multiplication, whilst, ideally, having a small sample flush volume for a fast response time.
2—It should produce a low level of optical fringes when used with a diverging coherent source such as a laser diode.

Previously, an optical cell geometry was disclosed that dispenses with the need to use a lens for collimating a laser source, while still providing pathlength multiplication. Due to the absence of a lens, the diverging light cone of the laser source may well intersect with the gas cell walls. This aperturing of the light cone of a coherent source will result in the formation of optical fringes. In the mathematical analysis described in this section, it will be shown that when aperturing a coherent source, the planar rectangular geometry of the gas cell may be preferable compared to a conventional tubular geometry, due to the significantly reduced resulting optical fringes.

Conventional tubular gas cells with optical windows at both ends and gas ports are commonly used in many spectroscopic applications. However, a planar rectangular gas cell geometry has an important practical advantage, when it comes to interfacing with a diverging coherent source such as a laser diode. When the diverging light cone of a laser source intersects the walls of the gas cell, an aperture is formed. The optical properties of a circular aperture versus a rectangular aperture, particularly in relation to optical fringes will now be discussed.

Fourier transform theory may be used to calculate the Fraunhofer diffraction pattern (diffraction at far field) from a rectangular aperture and the reciprocal relationship between the size of the diffraction pattern and the size of the aperture.

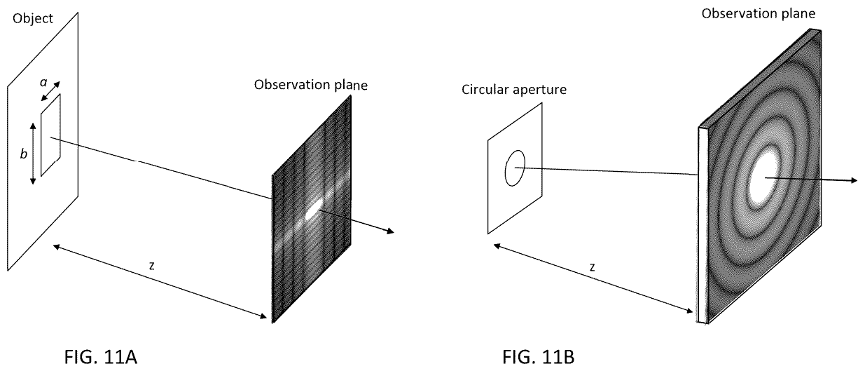

From FIG. 11A, if the object is a rectangular slit of width a in the x direction and b in the y direction and this aperture is illuminated by a plane wave at normal incidence, whose amplitude is in the plane of the aperture, then the rectangular aperture transmission function t(x,y) is given by:

$$t ( x , y ) = Π ( \frac{x}{a} ) Π ( \frac{y}{b} ) \qquad ( 11 )$$

Because the aperture is two-dimensional, a two-dimensional Fourier transform is used and the amplitude transmission function is separable in x and y. The diffraction amplitude distribution from the rectangular aperture is simply the one-dimensional transforms carried out individually for the x and y dimensions, where l is the wavelength of light. The diffracted amplitude at a distance z under the Fraunhofer approximation is:

$${f}_{x} ( x , y ) = {Ae}^{ikz} \frac{ab}{i λ z} sinc ( \frac{π ax}{λ z} ) sinc ( \frac{π by}{λ z} ) \qquad ( 12 )$$

Therefore, the diffraction pattern from a rectangular aperture is described by a sinc function. The intensity distribution of the Fraunhofer diffraction produced by the rectangular aperture is:

$${I}_{P} ( x , y ) = {I}_{0} \cdot {sinc ( \frac{π \cdot a \cdot x}{λ \cdot z} )}^{2} \cdot {sinc ( \frac{π \cdot b \cdot x}{λ \cdot z} )}^{2} \qquad ( 13 )$$

For a circular aperture (an example of which is shown in FIG. 11B): Using the transmission function for a circular aperture of diameter D and its Fourier transform, an expression for the diffracted amplitude may be derived at a distance z under the Fraunhofer approximation for a circular aperture. The diffraction pattern from a circular aperture is described by a Bessel function, which describes the well-known Airy rings at the observational plane.

$$I ( ρ , z ) = {I}_{0} \cdot {( \frac{2 \cdot J 1 ( π \cdot ρ \cdot \frac{D}{λ \cdot z} )}{π \cdot ρ \cdot \frac{D}{λ \cdot z}} )}^{2} \qquad ( 14 )$$

where r is the radial distance from the optical axis, D is the aperture diameter, and J1 is the First Bessel Function.

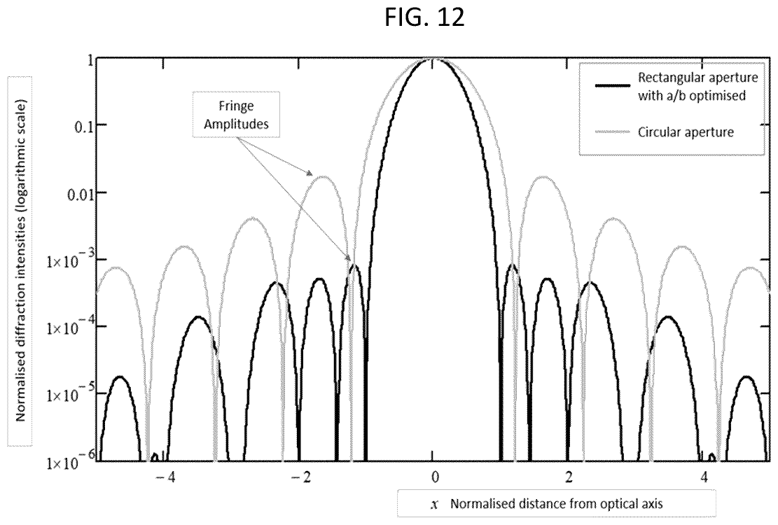

In order to perform a comparison of the rectangular aperture to the circular aperture, plots of normalised intensities for the diffraction amplitude may be used from Equations 13&14 (FIG. 12). As can be seen from FIG. 12, if the a/b ratio is at an optimal value, the fringes from a rectangular aperture are significantly lower than a circular aperture with similar overall cross-sectional area. The actual dimensions chosen for a given embodiment will depend on many other factors in addition to this, but this analysis may provide a useful guide to an optimal cell design.

In a preferred embodiment of a TDLS measurement system, the laser diode temperature is controlled by a thermo-electric cooler (TEC) and temperature feedback is provided by a temperature sensor, such as a thermistor, resistance temperature detector (RTD) or thermocouple. Both the laser temperature and current are controlled electronically to enable scanning over the desired gas absorption line. The unique optics described in this patent focuses the laser beam, having traversed through the gas cell, through an optical element on to the detector. The detector output, which incorporates the photo detector and amplifiers, is used with real-time signal processing software, which makes use of the 2nd harmonic signal and its unique absorption shape characteristics, such as height and width to determine the true gas concentration. Correlating or convolving the measured signal with a kernel function that is selective for a predicted signal distortion effect can mitigate the effects of fluctuations and other distortions on the absorption signal baseline, to reduce uncertainty in the determination of the measurand(s), as described in U.S. Pat. No. 10,234,378.

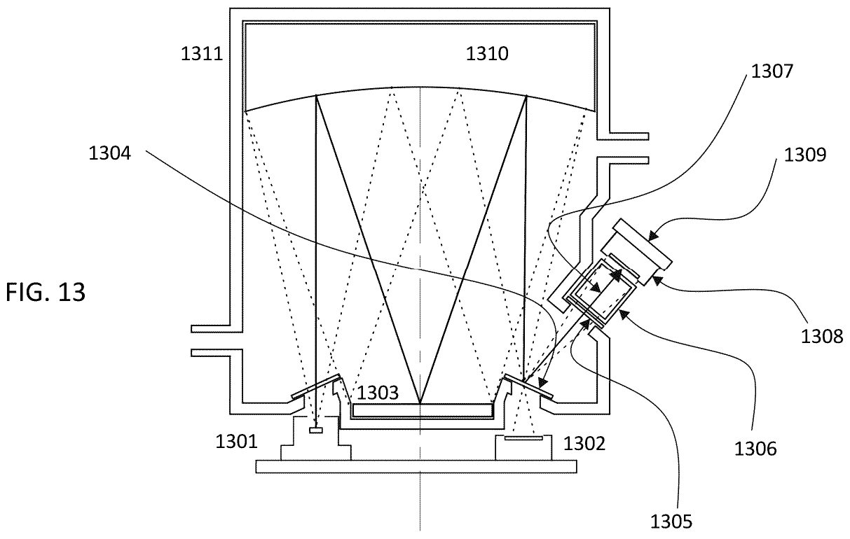

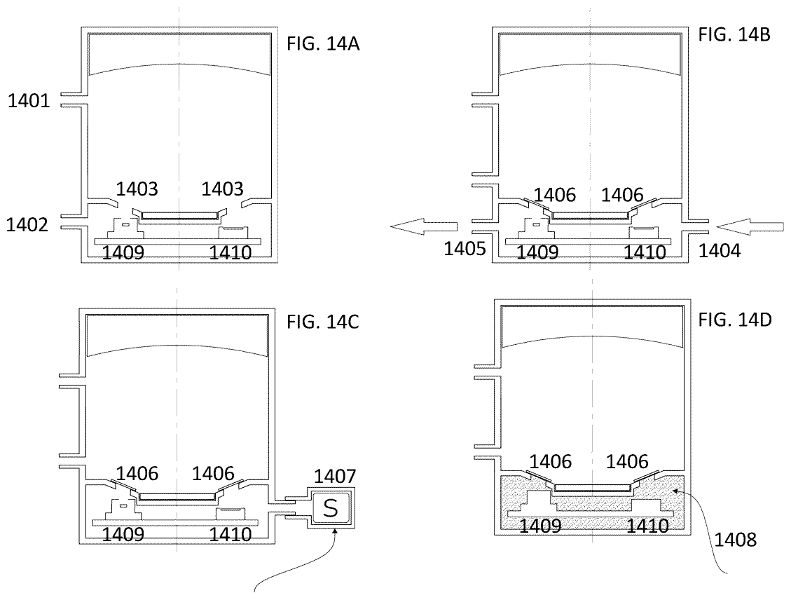

The stability of the scan current and the laser diode characteristics are paramount to the wavelength stability of the TDLS measurement. It is vital that in the case of either electronics or laser diode drift over time, the measurement is able to not only remain “locked” to the desired absorption line, but also produce a diagnostic report about the extent of this drift as a measure of preventative maintenance. A simple approach would be to enable an algorithm that detects the location of the gas absorption 2nd harmonic peak, and actively maintains this location in a feedback loop, by continuously fine adjusting the set point temperature of the laser diode. However, this approach assumes that the process gas flowing through the cell always contains some desired gas, which produces a measurable 2nd harmonic peak. In practice, no such assumption can be made. Real life processes may be highly variable and, for long periods of time, may contain either no desired gas, or, even worse, may contain a gas with a neighbouring interfering absorption line. For this reason, the instrument is ideally fitted with an on-board “wavelength reference” device, which, in a preferred embodiment, constantly monitors a real spectroscopic 2nd harmonic signal from a known reference gas, which is always present regardless of the process variations. Ideally, this reference gas can be the main gas of interest or another surrogate gas with absorption lines nearby. For practical cost and size constraints, this reference device should be as compact and low cost as possible. For example, in this illustration (FIG. 13) of one preferred embodiment of a TDLS instrument where the diverging beam from the source (1301) passes through the optical element (1304) and is then reflected by the first (1310) and second mirrors (1303) and after passing the second optical element (1304) is focused on the detector (1302). This detector (1302) is used for the primary measurand detection. In a preferred embodiment, a small proportion of the light incident on the optical element (1304) in front of the detector (1302) is reflected through a low volume sealed gas capsule (cuvette) (1306), with transmissive optical elements (1305) to the relevant wavelength range and filled with up to 100% concentration of the reference gas (1307) onto a secondary detector (1308) mounted on a printed circuit board (1309) for line lock to be maintained. It is important that sufficient optical absorbance of the reference gas in the reference cell takes place to create a detectable 2nd harmonic signal. This is achieved by a combination of sufficient pathlength and gas fill pressure. The dead space lies in between the at least one source (1409) and/or at least one detector (1410) and the at least one optical element (1406) on the sample cell (FIGS. 14A to 14D). Where appropriate, the dead space may be filled by a surrogate or substitute gas with at least one closely located absorption line, which is within the scan range of the diode laser and, ideally, lies outside the absorption line of the gas of interest and this method can optionally be used to perform wavelength lock.

The dead space may alternatively or additionally contain high levels of an interfering gas, such that the absorption is in the non-linear region of the Beer-Lambert absorption curve and the presence of the interfering gas within the sample has decreased impact on the measurement signal. In some embodiments, strong magnetic and/or electric fields may be used to split the absorption lines of the gas of interest (Zeeman and Stark effects) and hence obtain a wavelength lock with reduced cross interference.

The dead space between the at least one source (1409) and/or at least one detector (1410) and the at least one optical element (1406) on the sample cell (FIGS. 14A to 14D) may be a cause of measurement uncertainty, due to the presence of the gas species of interest or optical interferent. This interfering gas species may be present from the time of manufacture or through diffusion from surrounding environment and could be variable. This may be mitigated by several means (FIGS. 14A to 14D), such as removing the optical elements 1406 and allowing the sample gas to fill the dead space (FIG. 14A), flushing of the dead space with a non-optically absorbing gas, such as nitrogen (FIG. 14B) and/or chemical scrubbing for a specific gas or specific gases (FIG. 14C). However, in specific instances, this dead space may also be used advantageously to contain a lock-gas, such as described in the previous section. In the case of the gas of interest being used, the signal offset caused by the presence of this reference gas, may be subtracted from the measured signal. With reference to FIGS. 14A to 14D, a more detailed explanation of the above options will be given. In FIG. 14A, the optical elements 1406 have been removed for the sample gas to fill the dead space. This has the advantages of simplicity, reduced cost, longer pathlength, higher transmission and reduced etalons, however; this has the disadvantages of exposing the source (1409), the detector (1410) and other elements of the design to potentially harmful (e.g. corrosive and/or flammable) gases. In FIG. 14B, the dead space is sealed by the optical elements 1406, however; it is purged with a non-optically interfering gas. This has the advantages of eliminating the measurement uncertainty but has the disadvantage of needing a continuous supply of purge gas with increased complexity and cost. In FIG. 14C, where a scrubber 1407 is used to eliminate the interfering gases in the dead space, this has the advantage of not requiring a continuous supply of purge gas, however; the scrubber may become saturated over time requiring replacement and the scrubber material should be selected according to the application increasing complexity and cost.

Alternatively, as shown in FIG. 14D, the dead space may be filled with a gel or other suitable substance 1408, ideally approximately transparent to the wavelength range of interest and approximately refractive index matched to the optical element materials of the source 1409 and the detector 1410 and the optical elements 1406 of the cell and impermeable to gases. Additionally, the properties of 1408 must be approximately electrically and thermally insulative. The index matching minimises stray reflections and transmission losses and decreases etalon formation. The gel or the other suitable substance may also act as a secondary physical barrier to gas ingress, in case of the failure of the sample cell optical seal. This may be particularly relevant for flammable and/or toxic gas samples. In a preferred embodiment, a gel or other suitable substance 1408 may be injected/poured or placed by a suitable means into the dead space in order to completely fill the void between the optical elements of the source, the detector and the gas sample optical elements 1406. In a preferred embodiment, when the gel or other suitable substance is injected into the dead space, its viscosity should be chosen so as to allow complete flow access for avoidance of any bubble or void formation. This viscosity may be controlled by composition and/or temperature. Additionally, minimisation of (air) bubble formation may be enhanced by the use of a vacuum, when making and/or injecting the gel and/or setting the gel. Flexibility within the gel structure decreases the likelihood of crack formation due to aging or temperature cycling. The presence of bubbles within the gel may decrease the performance through scattering, absorption and etalon formation.

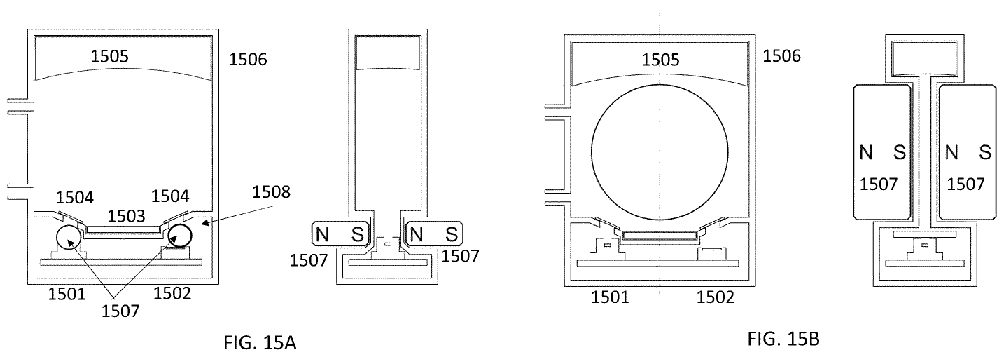

As previously described, magnetic and/or electric fields may be applied to the dead space (see FIG. 15A) and/or the sample volume (see FIG. 15B). In the case of FIG. 15A, the diverging beam from the source (1501) passes through the optical element (1504) into the sample cell (1506) where it is reflected by the first (1505) mirror and the second mirror (1503) and focused through a second optical element (1504) onto the detector (1502). In the case of the presence of measurand gas in the dead space as the beam passes through the dead space (1508) between the source (1501) and the optical element (1504) and between the second optical element (1504) and the detector (1502), absorption of the beam may take place resulting in measurement uncertainty. The presence of a magnetic and/or electric field in this dead space 1508 may induce splitting of these absorption lines by the Zeeman and/or Stark effects, which will result in decreased measurement uncertainty since the gas in the sample cell does not undergo similar splitting of lines. This reduction of measurement uncertainty can be achieved either using a constant magnetic and/or electric field, or in some embodiments using modulated magnetic and/or electric fields.

In the case of FIG. 15B, this similarly uses the Zeeman and/or Stark effect to induce absorption line splitting, however, in this case the sample cell gas experiences these effects.

In the case of a modulated field a comparison of the signal with and without the field applied may result in enhanced detection of the measurand due to reduction of any etalon effects in the cell.

In some embodiments, the features of 15A and 15B may be combined into a single device.

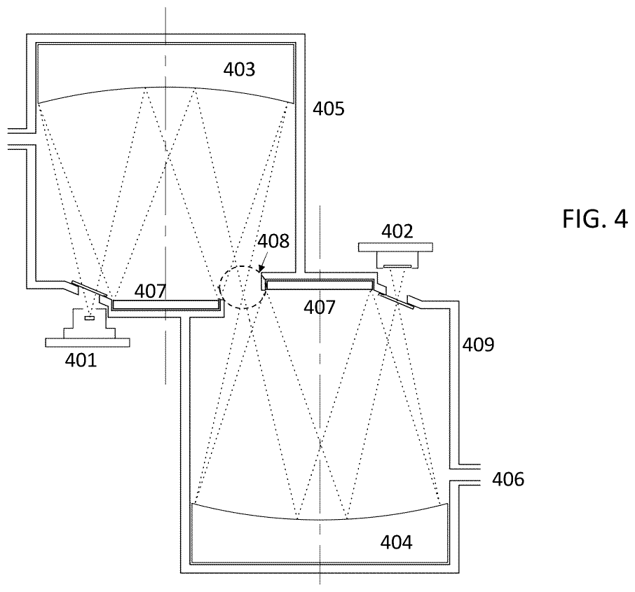

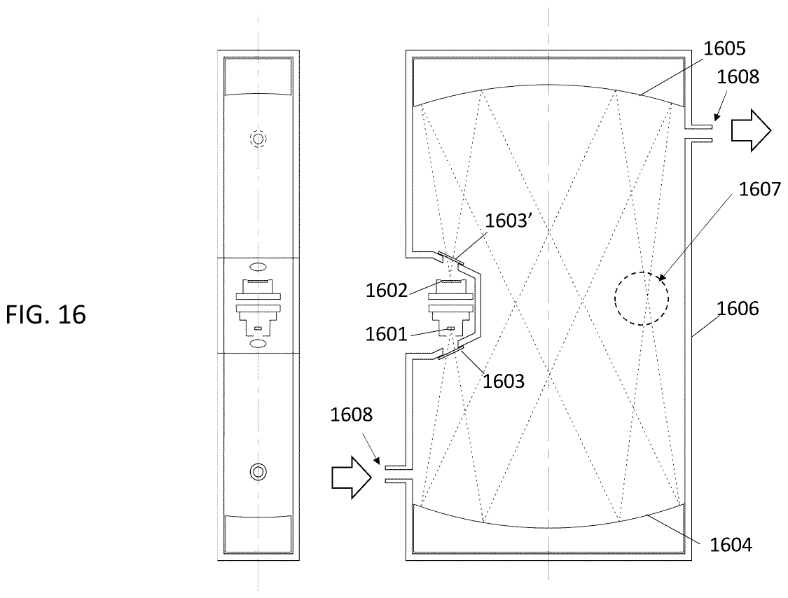

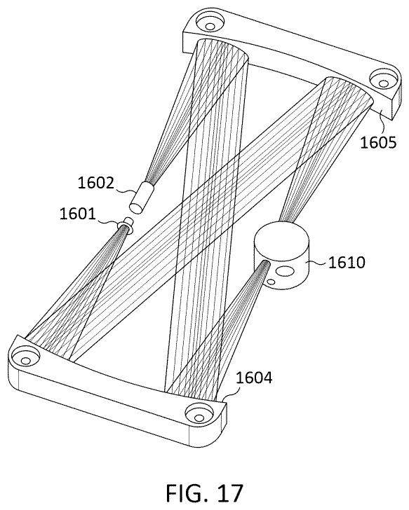

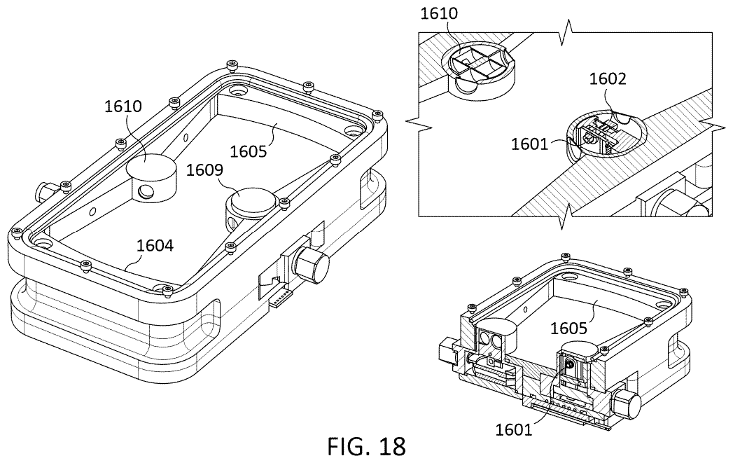

It is envisaged by the inventors that there are potentially many different embodiments using the optical design principles described in this patent to form a compact folded path spectroscopic cell. For example, FIG. 16 illustrates an embodiment with longer pathlength per cell length. This embodiment achieves an enhanced pathlength with simplicity of design and build compared to a modular system comprising two of the earlier-described structures (in the embodiment of FIG. 4). The diverging beam from the source (1601) passes through a first optical element (1603) and enters the sample cell (1606). Inside the sample cell multiple reflections occur between the first mirror (1604) and a second mirror (1605) as illustrated in FIG. 16. In such a simplified embodiment, the source and detector can be located back-to-back in a common housing 1609 (see FIG. 18) and mirrors (1604) and (1605) are identical cross-sectional slices of a spherical section. The outgoing beam passes through a second optical element (1603′) and is incident on the detector (1602). Optionally, as described in a previous section, a wavelength lock cell (1610 in FIGS. 17 and 18) may be included which may be preferentially located at position (1607) where a localised focal point forms and an optical element may be used to divert a small fraction of the beam through the optionally placed wavelength lock cell. All the earlier descriptions with regard to potential features and benefits of alternative embodiments apply equally to this or similar embodiments.

FIG. 17 illustrates the folded optical path of a transmitted divergent beam of light when reflected within the gas cell of FIG. 16, showing the light converging on the detector. A housing shown as turret 1610 can house the wavelength lock cell and/or optical filters. This folded optical path shows how the reflected divergent beam passes through the cell with a symmetrical path such that all light has a substantially equal path length.

FIG. 18 shows the main physical structures of an example apparatus according to FIGS. 16 and 17, including the housings 1609 and 1610, and the light source 1601 and detector 1602, and mirrors 1604 and 1605.

In some embodiments, the source and/or detector is remote mounted and the electromagnetic radiation is conducted to and from the apparatus using at least one fibre optic cable. This may have advantages where temperature and/or electromagnetic interference might render direct coupling impractical.

Set out below are examples of apparatus for optical gas detection and/or measurement. The features of these various examples can be combined.

A first compact apparatus for optical gas detection and/or measurement in an absorption spectroscopy system comprises:
a gas cell 307 for containing a gas sample or calibration gas with at least one gas exchange port 308 and at least one optical element 304 for allowing transmission of electromagnetic radiation of a desired wavelength range in and out of the gas cell; and
at least one source 301 of diverging or collimated electromagnetic radiation for transmitting electromagnetic radiation through a gas sample contained within the gas cell 307) and towards at least one detector 302;
two or more mirrors 305, 306 arranged in opposed relation to each other, including at least one curved mirror 306 arranged to reflect the transmitted electromagnetic radiation towards a second mirror 305, wherein the second mirror 305 is arranged to reflect the electromagnetic radiation back towards the at least one curved mirror, and wherein said two or more mirrors 305, 306 are arranged to reflect the electromagnetic radiation in a folded optical path through the gas sample towards the at least one detector 302 such that the transmitted diverging or collimated electromagnetic radiation is reflected towards the at least one detector 302;
at least one detector 302 to monitor absorption of electromagnetic radiation for at least one absorption wavelength or wavelength range associated with at least one gas species, by detecting transmitted electromagnetic radiation that is not absorbed; and
at least one analyser for analysing an output signal from the at least one detector to determine the presence and/or measure a parameter of at least one gas species within the gas sample.

In an example apparatus, the folded optical path through the gas sample is substantially symmetrical about a central optical axis or central point between the opposed mirrors, and the folded optical path has a substantially equal path length for electromagnetic radiation that is transmitted between the source and the detector and reflected by the mirrors.

An example apparatus for gas detection and/or measurement using absorption spectroscopy comprises:
a gas cell 1606 with at least one gas exchange port 1608;
at least one source 1601 of electromagnetic radiation, the source being arranged to transmit a diverging beam of electromagnetic radiation in a direction to pass through the gas cell 1606;
at least one detector 1602 for detecting electromagnetic radiation that is incident on the detector; and
at least first and second mirrors 1604, 1605 arranged substantially symmetrically within the gas cell, in opposed relation to each other, wherein at least the first mirror is a curved mirror and wherein the opposed mirrors are arranged to reflect the transmitted diverging beam in a folded optical path through the gas cell between the at least one source and at least one detector such that the reflected beam passes through the gas cell with a substantially symmetrical path and the reflected beam has a substantially equal path length and converges towards the at least one detector;
wherein at least one source is located at a position that is offset from a central optical axis that passes through the centre of curvature of the first mirror, such that transmitted electromagnetic radiation is incident on a first surface region of the first mirror 1604 at a non-zero angle relative to a direction normal to the first surface region and such that transmitted electromagnetic radiation that is incident on the first mirror is reflected away from the source towards the second mirror.

The offset source position may be between the first and second mirrors (as shown by way of example in FIGS. 16, 17 and 18).

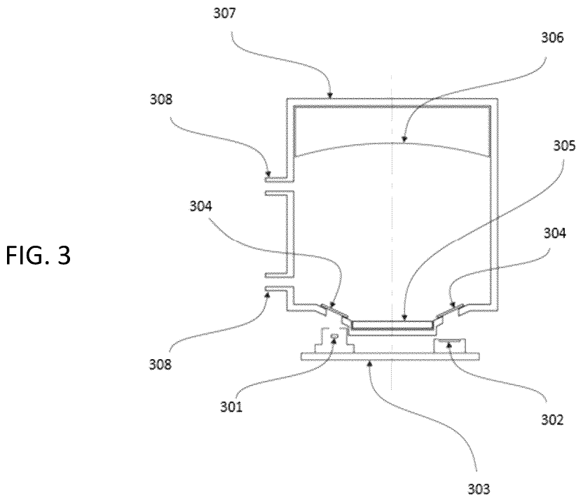

The substantially equal optical path of electromagnetic radiation within the reflected beam may be achieved by an apparatus with reflectional symmetry, such as shown in the examples of FIGS. 3, 7-8 and 13-16. The first and second mirrors may have a common central optical axis passing through a centre of curvature of the first mirror (see FIGS. 3, 7-8 and 13-16), and the transmitted beam follows a folded optical path that is substantially symmetrical about this central optical axis. In FIG. 16, the light source 1601 and detector 1602 are shown larger and positioned in a larger housing than would typically be required. In an optimal compact absorption apparatus, the light source is provided as a Chip-On-Board (COB) implementation with the light source located opposite the beam's convergence point (shown in the dotted circle 1607). In that arrangement, the light source 1601 and the convergence point 1607 may each be located at a distance from the two mirrors corresponding to half the radius of curvature of the mirrors. This results in the diverging beam following a symmetrical folded optical path, in which it is collimated by the first mirror 1604, and the collimated beam is then reflected by the second mirror 1605 to converge towards a point 1607 and then diverge again, and to be reflected by a second surface region of the first mirror 1604 so as to be collimated again. Finally, the beam is reflected by a second reflective region of the second mirror and converges towards the detector 1602.

As an alternative to the above-described examples, the folded optical path may comprise a system having two or more apparatus substantially as described above, to provide a longer optical path length. Such an arrangement is shown schematically in FIG. 4. Each of the two apparatus is substantially symmetrical about its respective central axis, and the combined system has approximate rotational symmetry about the beam's convergence point shown within the dotted circle 408. In FIG. 4, the light source 401 is shown canned in a container or support structure, and this is larger in the figure than would typically be the case. In an optimal compact absorption apparatus, the light source may be provided as a Chip-On-Board (COB) implementation with the light source in closer proximity to the entry window into the gas measurement cell than is shown schematically in FIG. 4. In a symmetrical arrangement, the light source and the two convergence points (shown in the dotted circle 408 and close to the detector) would be the same distance from the respective curved mirrors, which is also a feature of an optimal COB implementation of the apparatus of FIG. 16.

In a second example of the apparatus, the at least one curved mirror 306 comprises at least one spherical or approximately spherical mirror, and the apparatus is arranged to converge the transmitted electromagnetic diverging or collimated electromagnetic radiation towards the detector 302.

In a third example of the apparatus, the at least one source of electromagnetic radiation 301 is located at a distance from a spherical mirror 306 which is approximately equal to half the radius of curvature of that spherical mirror such that the diverging beam of electromagnetic radiation from the source that is incident on the spherical mirror 306 will be reflected as an approximately parallel beam.

A fourth example corresponding to the above-described third apparatus further comprises a planar or concave second mirror 305 positioned in opposed relation to the spherical mirror such that the parallel beam is reflected off the second mirror and is incident on the spherical mirror 306 for a second time, and is then reflected as a converging beam towards a detector 302, wherein the detector 302 is located at a distance from the spherical mirror 306 which is approximately half the radius of curvature of the spherical mirror 306.

In a fifth example corresponding to the above-described fourth apparatus, the second mirror 305 is also located at a distance from the spherical mirror 306 which is approximately half the radius of curvature of the spherical mirror.

In a sixth example apparatus, the electromagnetic radiation trajectory follows a folded path, wherein said folded path is provided by:
directing the output from a diverging or collimated electromagnetic source 301 towards the at least one spherical or approximately spherical mirror 306;
reflecting the electromagnetic radiation from the spherical or approximately spherical mirror 306 onto the second mirror 305, which may be an approximately flat or concave mirror;
reflecting the electromagnetic radiation from the second mirror 305 onto the spherical or an approximately spherical mirror 306;
reflecting the electromagnetic radiation from the spherical or approximately spherical mirror onto at least one optical detector 302.

In an example apparatus, the spherical or approximately spherical mirror 306 comprises a segment of a spherical surface or a plurality of segments of the same spherical surface.

In an example apparatus, the at least one source 301 and at least one detector 302 are mounted on a mount 303 approximately co-planar with each other and parallel to the plane of an approximately planar mirror or perpendicular to a plane which is normal to the centre of a concave second mirror 305.

An example apparatus has approximate central reflectional and/or rotational symmetry between the at least one source 301 and at least one detector 302.

An example system for absorption spectroscopy comprises an apparatus according to the above examples in combination with two or more additional mirrors located in the optical path between the source and the detector.

In an example apparatus, the at least one optical element comprises a window and constitutes both an inlet window and outlet window.

In an example apparatus, the at least one optical element consists of at least one inlet window and at least one outlet window, wherein the inlet window is separate from the outlet window.

In an example apparatus, the windows are wedge windows and/or attenuating windows and/or bandpass filters.

In an example apparatus, the window or windows are mounted at a non-zero angle relative to the approximately flat mirror or cylindrically concave mirror.

In an example apparatus, the window or windows are mounted at the Brewster (polarisation) angle.

In an example apparatus, the at least one source of electromagnetic radiation is a laser.

In an example apparatus, the laser is a tuneable diode laser (TDL) and current and/or temperature is used to tune the wavelength.

In an example apparatus, direct absorption spectroscopy is used to determine at least one parameter of at least one gas.

In another example, wavelength modulation spectroscopy is used to measure at least one parameter of at least one gas.

In another example apparatus, the at least one source of electromagnetic radiation is a broadband source. In an example, the broadband source is either an incandescent source or light emitting diode (LED).

In an example apparatus, the at least one detector is either a solid state photoconductive, photovoltaic, photomultiplier, bolometer or pyroelectric detector.

In an example apparatus, the inside surface of the sample cell is roughened and/or coated with an electromagnetic radiation absorbing layer to absorb electromagnetic radiation which could interfere with the signal.

In an example apparatus, the at least one source and at least one detector are mounted on the same printed circuit board (PCB). In an example, the PCB is mounted parallel to the second mirror.

In an example, a gas contained in the space between the optical element and the at least one source of electromagnetic radiation and/or the space between the at least one optical element and the at least one detector of electromagnetic radiation is used to provide a lock-line and/or verification and/or calibration line for the gas to be measured.

In an example apparatus, at least one bandpass filter is provided to limit the transmission band of the electromagnetic radiation.

In an example apparatus, a magnetic field source is arranged to apply a permanent and/or transient magnetic field and/or an electric field source is arranged to apply a permanent and/or transient electric field across the sample cell and/or across the space between the optical element and the at least one source of electromagnetic radiation and/or across the space between the at least one optical element and the at least one detector. In one example, the magnetic field source is at least one permanent magnet. In another example, the magnetic field source is at least one electromagnet. In one example, the magnetic field source is a combination of at least one permanent magnet and at least one electromagnet. In one example, the electric field is supplied by applying an electric field gradient between at least two electrodes.

In an example apparatus, the space between the source of electromagnetic radiation and the at least one optical element and/or the space between the electromagnetic radiation detector and the at least one optical element is sealed and flushed with a purge gas and/or scrubbed of any spectroscopically absorbing gas at the wavelengths of interest.

In an example apparatus, a spectroscopic measurement signal at twice the modulation excitation frequency is used to determine at least one parameter of at least one gas.

In an example apparatus for use in an absorption spectroscopy system, a spectroscopic measurement signal is processed in the frequency domain.

In one example, the signal is convolved with a kernel function chosen to minimise the effect of baseline noise.

In an example apparatus, the at least one optical element may constitute one or more of the following: a window, a refractive element, a reflective element, diffractive element or electromagnetic radiation pass band filter.

An example apparatus for optical gas detection and/or measurement in an absorption spectroscopy system, comprises:
a gas cell (307) for containing a gas sample or calibration gas with at least one gas exchange port (308) and at least one optical element (304) for allowing transmission of electromagnetic radiation of a desired wavelength range in and out of the gas cell; and
at least one source (301) of diverging electromagnetic radiation for transmitting a diverging beam of electromagnetic radiation through a gas sample contained within the gas cell (307);
two or more mirrors (305, 306) arranged in opposed relation to each other, including at least one curved mirror (306) arranged to reflect the transmitted electromagnetic radiation towards a second mirror (305), wherein the second mirror (305) is arranged to reflect the electromagnetic radiation towards the at least one curved mirror, and wherein said two or more mirrors (305, 306) are arranged to reflect the electromagnetic radiation in a folded optical path through the gas sample towards at least one detector (302) such that the transmitted diverging beam of electromagnetic radiation converges towards the at least one detector (302);
at least one detector (302) to monitor absorption of electromagnetic radiation for at least one absorption wavelength or wavelength range associated with at least one gas species, by detecting transmitted electromagnetic radiation that is not absorbed and is incident on the at least on detector, and generating an output signal indicative of the absorption of electromagnetic radiation; and
at least one processor for analysing the output signal from the at least one detector to determine the presence and/or measure a parameter of at least one gas species within the gas sample.

In an example, the opposed mirrors include two or more mirrors 305, 306 arranged in opposed relation to each other, including at least a first spherical or approximately spherical mirror 306 having a first surface region located in the optical path of the transmitted diverging beam, wherein the first mirror is located at a distance from the source that is less than the radius of curvature of the first mirror, and wherein the first mirror is oriented such that the diverging beam is incident on the first surface region at a non-zero angle relative to the first mirror's radial direction. In an example, the first mirror is arranged to reflect the transmitted electromagnetic radiation towards a second mirror 305, wherein the second mirror 305 is arranged to reflect the electromagnetic radiation towards a second surface region of the first curved mirror 306, and wherein said two or more mirrors 305, 306 are arranged to reflect the electromagnetic radiation in a folded optical path through the gas sample towards the at least one detector 302 such that the transmitted diverging beam of electromagnetic radiation converges towards the at least one detector 302.

In an example apparatus or system, the gas inlets are attached to gas conduits and arranged such that the sample gas flows in through the at least one gas inlet and out through the at least one gas outlet.

In an example apparatus or system, the at least one gas inlet and the at least one gas outlet consist of at least one diffusive element.

In an example apparatus or system, the same diffusive element is used to provide the at least one gas inlet and the at least one gas outlet.

In an example apparatus or system, a combination of direct flow and diffusion is used to pass the sample gas through the at least one gas inlet and out through the at least one gas outlet.

Another example apparatus or system comprises more than one source and/or detector.

Another example apparatus or system comprises at least one auxiliary optical detector, wherein reflected light not on the main optical measurement path is passed through at least one auxiliary optical element to at least one auxiliary optical detector for the purposes of obtaining a line-lock and/or validation reading. In one example, the reflected light is light reflected from a window or reflective element inside or outside the sample cell. In one example, at least one auxiliary optical element is a cuvette containing the gas of interest and/or an optical filter.

In an example, the sample cell is maintained at a controlled temperature and/or pressure.

In an example apparatus, at least one volume outside the gas cell is either sealed and scrubbed to remove impurities and/or purged with a non-optically absorbing purge gas.

In an example apparatus, the source and/or detector is remote mounted and the electromagnetic radiation is conducted to and/or from the device using at least one light guide or fibre optic cable.

In an example apparatus, at least one space outside the gas cell is filled with an interfering optically absorbing gas.

In an example apparatus at least one space outside the gas cell is filled with a gel. In an example apparatus, the gel is refractive index matched to at least one optical element that it is in contact with. In an example, the chemical and physical properties of the gel and/or application of reduced pressure is used to minimise the presence of voids within the gel structure.

In an example apparatus, the at least one source is a bare chip mounted directly on the PCB. In an example, the chip is a diode laser or LED.

In an example apparatus, stray reflections off surfaces other than the first and second mirrors are used to increase the overall optical throughput and improve signal to noise, where no suppression of reflections is used and/or enhancement of stray reflections is made. In an example, the enhancement of stray reflections consists of applying a reflective layer to at least one surface within the sample cell.

In another example, an apparatus for optical gas detection and/or measurement, for use in an absorption spectroscopy system, comprises:
a gas cell (307) for containing a gas sample or calibration gas with at least one gas exchange port (308) and at least one optical element (304) for allowing transmission of electromagnetic radiation of a desired wavelength range in and out of the gas cell; and
at least one source (301) of diverging electromagnetic radiation for transmitting a diverging beam of electromagnetic radiation through a gas sample contained within the gas cell (307);
two or more mirrors (305, 306) arranged in opposed relation to each other, including at least a first spherical or approximately spherical mirror (306) having a first surface region located in the optical path of the transmitted diverging beam, wherein the first mirror is located at a distance from the source that is less than the radius of curvature of the first mirror, and wherein the first mirror is oriented such that the diverging beam is incident on the first surface region at a non-zero angle relative to the first mirror's radial direction, wherein the first mirror is arranged to reflect the transmitted electromagnetic radiation towards a second mirror (305), wherein the second mirror (305) is arranged to reflect the electromagnetic radiation towards a second surface region of the first mirror (306), and wherein said two or more mirrors (305, 306) are arranged to reflect the electromagnetic radiation in a folded optical path through the gas sample towards at least one detector (302) such that the transmitted diverging beam of electromagnetic radiation converges towards the at least one detector (302); at least one detector (302) to monitor absorption of electromagnetic radiation for at least one absorption wavelength or wavelength range associated with at least one gas species, by detecting transmitted electromagnetic radiation that is not absorbed and is incident on the at least one detector, and generating an output signal indicative of the absorption of electromagnetic radiation; and
at least one analyser for analysing the output signal from the at least one detector to determine the presence and/or measure a parameter of at least one gas species within the gas sample.

What is claimed is:

1. An apparatus for gas detection and/or measurement using absorption spectroscopy, comprising:
a gas cell with at least one gas exchange port;
at least one source of electromagnetic radiation, the source being arranged to transmit a diverging beam of electromagnetic radiation in a direction to pass through the gas cell;
at least one detector for detecting electromagnetic radiation that is incident on the detector; and
at least first and second mirrors arranged within the gas cell, in opposed relation to each other, wherein at least the first mirror is a curved mirror and wherein the opposed mirrors are arranged to reflect the transmitted beam in a folded optical path through the gas cell between the at least one source and at least one detector such that the reflected beam passes through the gas cell with a substantially equal path length and is reflected towards the at least one detector;
wherein at least one source is located at a position that is offset from a central optical axis that passes through the centre of curvature of the first mirror, such that transmitted electromagnetic radiation is incident on a first surface region of the first mirror at a non-zero angle relative to a direction normal to the first surface region and such that the transmitted electromagnetic radiation that is incident on the first mirror is reflected away from the source towards the second mirror, and wherein the second mirror is arranged to reflect the electromagnetic radiation towards a second surface region of the first mirror.

2. An apparatus according to claim 1, wherein the curved first mirror and second mirror are arranged to reflect the transmitted beam such that the reflected beam converges towards the detector.

3. An apparatus according to claim 1, wherein the offset source position is located in between the first and second mirrors.

4. An apparatus according to claim 1, wherein the first and second mirrors are arranged with a common axis of symmetry passing through a centre of curvature of the first mirror, which axis of symmetry is parallel to the central optical axis of the transmitted beam, such that the transmitted beam is reflected in a folded optical path that is substantially symmetrical about the common axis of symmetry.

5. An apparatus according to claim 1, wherein the first mirror is located at a distance from the source that is less than the radius of curvature of the first mirror.

6. An apparatus according to claim 5, wherein the at least one source of electromagnetic radiation is located at a distance from the first mirror which is approximately equal to half the radius of curvature of that first mirror such that the diverging beam of electromagnetic radiation from the source that is incident on the first mirror is reflected as an approximately parallel beam.

7. An apparatus according to claim 6, wherein the second mirror is a planar or curved second mirror positioned in opposed relation to a first spherical mirror such that the approximately parallel beam is reflected off the second mirror and is incident on the first spherical mirror for a second time, and is then reflected as a converging beam towards a detector, wherein the detector is located at a distance from the first spherical mirror which is approximately half the radius of curvature of the first spherical mirror.

8. An apparatus according to claim 7, wherein the second mirror is located at a distance from the spherical mirror which is approximately half the radius of curvature of the spherical mirror.

9. An apparatus according to claim 1, wherein the first mirror comprises a plurality of separated surface regions of the same spherical surface.

10. An apparatus according to claim 1, wherein the at least one source and at least one detector are mounted on a common substrate or sub-mount and are arranged approximately co-planar with each other in a plane that is either parallel to the plane of an approximately planar second mirror or perpendicular to a plane which is normal to the centre of a concave second mirror.

11. An apparatus according to claim 1, having approximate central reflectional and/or rotational symmetry such that the transmitted beam follows a substantially equal optical path length between the at least one source and at least one detector.

12. An apparatus according to claim 1, further comprising two or more additional mirrors located in the optical path between the source and the detector.

13. An apparatus according to claim 1, further comprising at least one optical element which comprises an inlet window and outlet window for electromagnetic radiation to pass into and out of the gas cell.

14. An apparatus according to claim 13, wherein the window or windows are mounted at a non-zero tilt angle relative to an approximately planar second mirror or relative to a direction perpendicular to a plane which is normal to the centre of a cylindrically concave second mirror.

15. An apparatus according to claim 14, wherein the window or windows are mounted at the Brewster (polarisation) angle.

16. An apparatus according to claim 1, wherein the at least one source of electromagnetic radiation is a laser.

17. An apparatus according to claim 16, wherein the laser is a tunable diode laser (TDL) and current and/or temperature is used to tune the wavelength of the transmitted electromagnetic radiation, and wherein direct absorption spectroscopy is used to determine at least one parameter of at least one gas.

18. An apparatus according to claim 16, wherein the laser is a tunable diode laser (TDL) and current and/or temperature is used to tune the wavelength of the transmitted electromagnetic radiation, and wherein wavelength modulation spectroscopy is used to measure at least one parameter of at least one gas.

19. An apparatus according to claim 1, wherein the at least one source of electromagnetic radiation is a broadband source.

20. An apparatus according to claim 1, wherein the inside surface of the sample cell is roughened and/or coated with an electromagnetic radiation absorbing layer to absorb electromagnetic radiation, thereby to mitigate potential interference with the signal.

21. An apparatus according to claim 1, wherein the at least one source and at least one detector are mounted on the same printed circuit board (PCB).

22. An apparatus according to claim 21, wherein the PCB is mounted parallel to the second mirror.

23. An apparatus according to claim 1, wherein a gas contained in the space between the optical element and the at least one source of electromagnetic radiation and/or the space between the at least one optical element and the at least one detector of electromagnetic radiation is used to provide a lock-line and/or verification and/or calibration line for the gas to be measured.

24. An apparatus according to claim 1, wherein at least one bandpass filter is provided to limit the transmission band of the electromagnetic radiation.

25. An apparatus according to claim 1, wherein a magnetic field source is arranged to apply a permanent and/or transient magnetic field and/or an electric field source is arranged to apply a permanent and/or transient electric field across the sample cell and/or across the space between the optical element and the at least one source of electromagnetic radiation and/or across the space between the at least one optical element and the at least one detector.

26. An apparatus according to claim 1, wherein the space between the source of electromagnetic radiation and the at least one optical element and/or the space between the electromagnetic radiation detector and the at least one optical element is sealed and flushed with a purge gas and/or scrubbed of any spectroscopically absorbing gas at the wavelengths of interest.

27. An apparatus according to claim 1, wherein the at least one gas exchange port of the gas cell comprises one or more gas inlets and one or more gas outlets, wherein the gas inlets are attached to gas conduits and arranged such that the sample gas flows in through the at least one gas inlet and out through the at least one gas outlet or wherein the at least one gas inlet and the at least one gas outlet consist of at least one diffusive element.

28. An apparatus according to claim 1, comprising more than one source and/or detector.

29. An apparatus according to claim 1, comprising at least one auxiliary optical detector, wherein reflected light not on the main optical measurement path is passed through at least one auxiliary optical element to at least one auxiliary optical detector for the purposes of obtaining a line-lock and/or validation reading.

30. An apparatus according to claim 29, wherein the reflected light that is not on the main optical measurement path is light reflected from a window or reflective element inside or outside the sample cell.

31. An apparatus according to claim 29, wherein said at least one auxiliary optical element is a cuvette containing the gas of interest and/or an optical filter.

32. An apparatus according to claim 1, wherein at least one volume located in the optical path of the transmitted electromagnetic radiation and outside the gas cell is either sealed and scrubbed to remove impurities and/or purged with a non-optically absorbing purge gas.

33. An apparatus according to claim 1, wherein the source and/or detector is remote-mounted and the electromagnetic radiation is conducted to and/or from the device using at least one light guide or fibre optic cable.

34. An apparatus according to claim 1, wherein at least one volume within the apparatus, which volume is located in the optical path of the transmitted electromagnetic radiation but outside the gas cell, is filled with an interfering optically absorbing gas.

35. An apparatus according to claim 1, wherein at least one volume within the apparatus, which volume is located in the optical path of the transmitted electromagnetic radiation but outside the gas cell, is filled with an optically transmissive filler material.

36. An apparatus according to claim 35, wherein the optically transmissive filler material is refractive index matched to at least one optical element that it is in contact with.

37. An apparatus according to claim 35, wherein chemical and physical properties of the optically transmissive filler material and/or application of reduced pressure is used to minimise the presence of voids within the filler material structure.

38. An apparatus according to claim 1, wherein the at least one source and/or at least one detector is a bare chip mounted directly on a PCB in a chip-on-board (COB) configuration.

39. An apparatus according to claim 1, wherein stray reflections are used to increase the overall optical throughput and improve signal to noise, where no suppression of reflections is used and/or enhancement of stray reflections is made.

40. An apparatus or system according to claim 39, wherein the enhancement of stray reflections consists of applying a reflective layer to at least one surface within the sample cell.

41. An apparatus for gas detection and/or measurement using absorption spectroscopy, the apparatus comprising:
a gas cell with at least one gas exchange port;
at least one source of electromagnetic radiation, the source being arranged to transmit a beam of electromagnetic radiation in a direction to pass through the gas cell;
at least one detector for detecting electromagnetic radiation that is incident on the detector; and
at least first and second mirrors arranged within the gas cell in opposed relation to each other, wherein at least the first mirror is a curved mirror and wherein the opposed mirrors are arranged to create a reflected optical path through the gas cell between the at least one source and at least one detector;
wherein at least one source is located between the opposed mirrors at a position that is offset from a centre of curvature of the first mirror such that transmitted electromagnetic radiation that is incident on the first mirror is reflected away from the source towards the second mirror.

42. An apparatus according to claim 41, further comprising a spectroscopic analyser for analysing an output signal from the at least one detector to detect the presence and/or measure a parameter of one or more gas species within the gas cell.

43. An apparatus according to claim 41, wherein the first and second mirrors are curved mirrors and the at least one detector is located between the opposed mirrors at a position that is offset from a centre of curvature of the first and second mirrors.

44. An apparatus according to claim 43, wherein the first mirror is a spherical mirror.

45. An apparatus according to claim 44, wherein the second mirror is a spherical mirror.

46. An apparatus according to claim 41, wherein the at least one source transmits a diverging beam towards the first mirror and the mirrors are arranged to automatically converge the diverging beam towards the at least one detector.

47. An apparatus according to claim 46, wherein the diverging beam of electromagnetic radiation is incident on a first surface region of the first mirror at a non-zero angle relative to a direction normal to the first surface region.

48. An apparatus according to claim 47, wherein the second mirror is arranged such that electromagnetic radiation reflected from the first surface region of the first mirror is incident on a first surface region of the second mirror at a non-zero angle relative to a direction normal to the first surface region of the second mirror so as to reflect incident radiation towards a second surface region of the first mirror, and is then reflected by the second surface region of the first mirror towards a second surface region of the second mirror, and is then incident on the second mirror to be reflected by the second mirror towards the at least one detector, thereby to form a reflected optical path through the gas cell with automatic convergence of the transmitted diverging beam towards the at least one detector.

49. An apparatus according to claim 41, wherein the at least one source and at least one detector are co-located within a housing between the opposed mirrors.

50. An apparatus according to claim 49, wherein the housing comprises at least first and second optical elements on opposite sides of the housing, wherein the first optical element is optically aligned with a source for allowing transmission of electromagnetic radiation from the source into the gas cell, and the second optical element is optically aligned with a detector for allowing reflected electromagnetic radiation to pass from the gas cell towards the detector.

51. An apparatus according to claim 50, wherein the source is arranged to transmit electromagnetic radiation in a transmission direction through the first optical element into the gas cell towards the first mirror, and the detector is arranged on an opposite side of the source from the transmission direction to detect electromagnetic radiation reflected from the second mirror towards the detector through the second optical element from a direction opposite to the transmission direction.

52. An apparatus according to claim 51, wherein the first optical element is a window arranged at a non-zero tilt angle relative to the transmission direction, and second optical element is a window arranged at a non-zero tilt angle relative to the direction of electromagnetic radiation that is reflected towards the detector.

53. An apparatus according to claim 52, wherein the windows are mounted at the Brewster polarisation angle relative to the direction of electromagnetic radiation that is incident on them.

54. An apparatus according to claim 41, wherein the at least one source is located at a distance from the first mirror that is less than a first radius of curvature of the first mirror.

55. An apparatus according to claim 54, wherein the first mirror is arranged within the gas cell at a distance from the at least one source of approximately half the first radius of curvature of the first mirror.

56. An apparatus according to claim 41, wherein substantially all radiation that is incident on the detector has an equal path length within the gas cell.

57. An apparatus according to claim 41, wherein the at least one source of electromagnetic radiation is a laser or a broadband source.

58. An apparatus according to claim 42, wherein the spectroscopic analyser is adapted to determine at least one parameter of at least one gas via direct absorption spectroscopy or via wavelength modulation spectroscopy.

59. An apparatus according to claim 41, wherein the inside surface of the gas cell other than the mirrors is roughened and/or coated with an electromagnetic radiation absorbing layer to absorb electromagnetic radiation.

60. An apparatus according to claim 41, wherein the at least one source and at least one detector are mounted on opposite sides of the same printed circuit board (PCB).

61. An apparatus according to claim 41, wherein at least one bandpass filter is provided to limit the transmission band of the electromagnetic radiation.

62. An apparatus according to claim 61, wherein the at least one bandpass filter is provided in a housing located within the gas cell at a point of convergence of the reflected radiation.

63. An apparatus according to claim 41, wherein a magnetic field source is arranged to apply a permanent and/or transient magnetic field and/or an electric field source is arranged to apply a permanent and/or transient electric field across the gas cell.

64. An apparatus according to claim 41, wherein a magnetic field source is arranged to apply a permanent and/or transient magnetic field and/or an electric field source is arranged to apply a permanent and/or transient electric field across a space between a source and its optically aligned first optical element and/or across a space between a detector and its optically aligned second optical element.

65. An apparatus according to claim 50, wherein a space between a source of electromagnetic radiation and the optically aligned first optical element, and/or a space between the electromagnetic radiation detector and the optically aligned second optical element, is sealed and flushed with a purge gas and/or scrubbed of interferent gases.

66. An apparatus according to claim 41, comprising more than one source and/or detector.
